(19) United States
(12) Patent Application Publication
(10) Pub. No.: US 2025/0045911 A1
(43) Pub. Date: Feb. 6, 2025

(54) COMPUTER IMPLEMENTED METHOD FOR DEFECT DETECTION IN AN OBJECT COMPRISING INTEGRATED CIRCUIT PATTERNS AND CORRESPONDING COMPUTER-READABLE MEDIUM, COMPUTER PROGRAM AND SYSTEM

(71) Applicant: Carl Zeiss SMT GmbH, Oberkochen (DE)

(72) Inventors: Alexander Freytag, Erfurt (DE); Bjoern Barz, Jena (DE); Mario Kanka, Jena (DE); Bjoern Froehlich, Jena (DE); Bjoern Brauer, Magstadt (DE); Xuan Truong Nguyen, Berlin (DE); Esther Klann, Berlin (DE)

(21) Appl. No.: 18/792,737

(22) Filed: Aug. 2, 2024

(30) Foreign Application Priority Data
Aug. 4, 2023 (DE) 102023120810.1

(51) Int. Cl. G06T 7/00

(52) U.S. Cl. CPC G06T 7/001; G06T 2207/20081; G06T 2207/20084; G06T 2207/30148

(57) ABSTRACT

The invention relates to a computer implemented method for defect detection in an object comprising integrated circuit patterns comprising: obtaining an imaging dataset and a reference dataset of the object; generating an input representation of a subset of the imaging dataset and a reference representation of a corresponding subset of the reference dataset in a feature space; and detecting defects in the object by comparing the input representation to the reference representation in the feature space. The invention also relates to a corresponding computer-readable medium, computer program product and system for defect detection.

### CROSS-REFERENCE TO RELATED APPLICATION

This application claims benefit under 35 U.S.C. § 119 (a) of German patent application 10 2023 120 810.1, filed on Aug. 4, 2023, which is incorporated herein by reference in its entirety.

### TECHNICAL FIELD

The invention relates to systems and methods for quality assurance of objects comprising integrated circuit patterns, more specifically to a computer implemented method, a computer-readable medium, a computer program product and a corresponding system for defect detection in an imaging dataset of such an object. By comparing the imaging dataset to a reference dataset of the object defects can be detected. The method, computer-readable medium, computer program product and system can be utilized for quantitative metrology, process monitoring, defect detection and defect review in objects comprising integrated circuit patterns, e.g., in photolithography masks, reticles or wafers.

### BACKGROUND

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes. Dimensions, shapes and placements of the semiconductor structures and patterns are subject to several influences. One of the most crucial steps is the photolithography process.

Photolithography is a process used to produce patterns on the substrate. The patterns to be printed on the surface of the substrate are generated by computer-aided-design (CAD). From the design, for each layer a photolithography mask is generated, which contains a magnified image of the computer-generated pattern to be etched into the substrate. The photolithography mask can be further adapted, e.g., by use of optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum feature size or critical dimension is below 10 nm, for example 7 nm or 5 nm, and is approaching feature sizes below 3 nm in near future. While the complexity and dimensions of the semiconductor structures are growing into the 3^{rd} dimension, the lateral dimensions of integrated semiconductor structures are becoming smaller. Producing the small structure dimensions imaged onto the wafer requires photolithographic masks or templates for nanoimprint photolithography with ever smaller structures or pattern elements. The production process of photolithographic masks and templates for nanoimprint photolithography is, therefore, becoming increasingly more complex and, as a result, more time-consuming and ultimately also more expensive. With the advent of EUV photolithography scanners, the nature of masks changed from transmission-based to reflection-based patterning.

On account of the tiny structure sizes of the pattern elements of photolithographic masks or templates, it is not possible to exclude errors during mask or template production. The resulting defects can, for example, arise from degeneration of photolithography masks or particle contamination. Of the various defects occurring during semiconductor structure manufacturing, photolithography related defects make up nearly half of the number of defects. Hence, in semiconductor process control, photolithography mask inspection, review, and metrology play a crucial role to monitor systematic defects. Defects detected during quality assurance processes can be used for root cause analysis, for example, to modify or repair the photolithography mask. The defects can also serve as feedback to improve the process parameters of the manufacturing process, e.g., exposure time, focus variation, etc.

Photolithography mask inspection needs to be done at multiple points in time in order to improve the quality of the photolithography masks and to maximize their usage cycles. Once the photolithography mask is fabricated according to the requirements, an initial quality assessment of the photolithography mask is done at the mask house before it is shipped to the wafer fab. Semiconductor device design and photolithography mask manufacturing quality are verified by different procedures before the photolithography mask enters a semiconductor fabrication facility to begin production of integrated circuits. The semiconductor device design is checked by software simulation to verify that all features print correctly after photolithography in manufacturing. The photolithography mask is inspected for defects and measured to ensure that the features are within specification. The data gathered during this process becomes the golden baseline or reference for further inspections to be performed at the mask house or wafer fab. Any defects found on the photolithography mask are validated using a review tool followed by a decision of sending the photolithography mask for repair or decommissioning the mask and ordering a new one. At the wafer fab, the photolithography mask is scanned to find additional defects called “adders” compared to the last scan performed at the mask house. Each of these adders is analyzed using a review tool. In case of a particle defect, the particle is removed. In case of a pattern-based defect the photolithography mask is either repaired, if possible, or replaced by a new one. The inspection process is repeated after every few photolithography cycles.

Each defect in the photolithography mask can lead to unwanted behavior of the produced wafer, or a wafer can be significantly damaged. Therefore, each defect must be found and repaired if possible and necessary. Reliable and fast defect detection methods are, therefore, important for photolithography masks.

Apart from defect detection in photolithography masks, defect detection in wafers is also crucial for quality management. During the manufacturing of wafers many defects apart from photolithography mask defects can occur, e.g., during etching or deposition. For example, bridge defects can indicate insufficient etching, line breaks can indicate excessive etching, consistently occurring defects can indicate a defective mask and missing structures hint at non-ideal material deposition etc. Therefore, a quality assurance process and a quality control process are important for ensuring high quality standards of the manufactured wafers.

Apart from quality assurance and quality control, defect detection in wafers is also important during process window qualification (PWQ). This process serves for defining windows for a number of process parameters mainly related to different focus and exposure conditions in order to prevent systematic defects. In each iteration a test wafer is manufactured based on a number of selected process parameters, e.g., exposure time, focus variation, etc., with different dies of the wafer being exposed to different manufacturing conditions. By detecting and analyzing the defects in the different dies based on a quality assurance process, the best manufacturing process parameters can be selected, and a window or range can be established for each process parameter from which the respective process parameter can be selected. In addition, a highly accurate quality control process and device for the metrology of semiconductor structures in wafers is required. The recognized defects can, thus, be used for monitoring the quality of wafers during production or for process window establishment. Reliable and fast defect detection methods are, therefore, important for objects comprising integrated circuit patterns.

In order to analyze large amounts of data requiring large amounts of measurements to be taken, machine learning methods can be used. Machine learning is a field of artificial intelligence. Machine learning methods generally build a parametric machine learning model based on training data consisting of a large number of samples. After training, the method is able to generalize the knowledge gained from the training data to new previously unencountered samples, thereby making predictions for new data. There are many machine learning methods, e.g., linear regression, k-means, support vector machines, neural networks or deep learning approaches.

Deep learning is a class of machine learning that uses artificial neural networks with numerous hidden layers between the input layer and the output layer. Due to this complex internal structure the networks are able to progressively extract higher-level features from the raw input data. Each level learns to transform its input data into a slightly more abstract and composite representation, thus deriving low and high level knowledge from the training data. The hidden layers can have differing sizes and tasks such as convolutional or pooling layers.

Methods for the automatic detection of defects in objects comprising integrated circuit patterns include defect detection algorithms, which are often based on a die-to-die or die-to-database principle.

The die-to-die principle compares an imaging dataset of portions of an object with a reference dataset of the same portions of another identical object. The discovered deviations are treated as defects. However, this method requires the availability and time-consuming scanning of two corresponding portions of objects and exact knowledge about their relative position. In addition, it fails in case of repeater defects.

The die-to-database principle compares an image location of an object with a reference dataset from a database, e.g., a previously recorded image or a simulated image or a CAD file, thereby discovering deviations from the ideal data. Unexpected patterns in the imaging dataset are detected due to large differences. Repeater defects can be handled. However, die-to-database methods are computationally expensive since they require an intermediate registration step to align the imaging dataset to the reference dataset.

For example, the US 2019/0130551 A1 discloses a die-to-database method for defect detection. In a first step, a reference dataset is generated from a number of scan images of a reference wafer, e.g., by a median filter. Imaging datasets are obtained from a target wafer and defects are detected based on pixel value differences of an imaging dataset and the reference dataset.

Both die-to-die or die-to-database approaches, usually rely on a comparison of images or image portions, e.g., acquired images or generated artificial images. Such comparisons are computationally demanding, since the images to be compared have to be generated. In addition, a lot of redundant information is contained in the images. Since the essential information for defect detection is easily lost in the mass of information, the accuracy and robustness of defect detection methods is limited. In addition, die-to-die and die-to-database approaches require the imaging dataset and the reference dataset to have the same appearance, i.e., images statistics, image modality, image generation type and image alignment, e.g., a SEM image is difficult to compare to polygons from a CAD file. The applicability of such defect detection methods is, thus, limited.

It is, therefore, a feature of the invention to detect defects in objects comprising integrated circuit patterns with high accuracy and robustness. It is another feature of the invention to reduce the runtime and to increase the throughput of defect detection methods. It is also a feature of the invention to extend the applicability of the defect detection method. Another feature of the invention is to provide methods for defect detection that do not require expert knowledge of users for defining defects.

The features are achieved by the invention specified in the independent claims. Advantageous embodiments and further developments of the invention are specified in the dependent claims.

### SUMMARY

Embodiments of the invention concern computer implemented methods, computer-readable media and systems implementing defect detection methods for objects comprising integrated circuit patterns.

An integrated circuit pattern can, for example, comprise semiconductor structures. An object comprising integrated circuit patterns can refer, for example, to a photolithography mask, a reticle or a wafer. In a photolithography mask or reticle the integrated circuit patterns can refer to mask structures used to generate semiconductor patterns in a wafer during the photolithography process. In a wafer the integrated circuit patterns can refer to semiconductor structures, which are imprinted on the wafer during the photolithography process.

The object comprising integrated circuit patterns may be a photolithography mask. The photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide.

An embodiment of the invention involves a computer implemented method for defect detection in an object comprising integrated circuit patterns, the method comprising: obtaining an imaging dataset and a reference dataset of the object; generating an input representation of a subset of the imaging dataset and a reference representation of a corresponding subset of the reference dataset in a feature space, wherein the feature space is configured to preserve the information of the subset of the imaging dataset and of the subset of the reference dataset that is relevant for the detection of defects; and detecting defects in the object by comparing the input representation to the reference representation in the feature space. The subset of the imaging dataset and the subset of the reference dataset are, thus, mapped to different representations in the same feature space. The detected defects can be used for assessing the quality of the object, e.g., the suitability of the photolithography mask for wafer production or the quality of a printed wafer. Depending on the detected defects, the object can be repaired or discarded.

The term “feature space” refers to a vector space that is associated with a set of features that are relevant for defect detection, i.e., they preserve the information of the subset of the imaging dataset and of the subset of the reference dataset that is relevant for the detection of defects. The input representation and the reference representation can comprise feature vectors containing coordinates in the feature space. Alternatively, the input representation and the reference representation can comprise a probability distribution in the feature space. Other representations are conceivable.

The term “defect” refers to a localized deviation of an integrated circuit pattern from an a priori defined norm of the integrated circuit pattern. For instance, a defect of an integrated circuit pattern, e.g., of a semiconductor structure, can result in malfunctioning of an associated semiconductor device. Depending on the detected defect, for example, the photolithography process can be improved, or photolithography masks or wafers can be repaired or discarded. The norm of the integrated circuit pattern can be defined by a corresponding reference object or dataset, e.g., a model dataset (e.g., using a CAD design) or an acquired defect-free dataset.

Instead of directly comparing the subset of the imaging dataset to the subset of the reference dataset in the image space, the comparison is carried out in a feature space configured to preserve the information of the subset of the imaging dataset and of the subset of the reference dataset that is relevant for the detection of defects. This has the following advantages. The feature space contains the representation of the subset of the imaging dataset and of the corresponding subset of the reference dataset with respect to some pre-computed features. In this way, the most relevant information for the detection of defects is extracted from the subset of the imaging dataset and from the subset of the reference dataset. Thus, the accuracy and the robustness of the defect detection method is improved. Furthermore, the representation of the subset of the imaging dataset and the representation of the subset of the reference dataset in a feature space is an abstract representation independent from the image space. On the one hand, this abstract representation allows for a comparison of the subset of the imaging dataset and the subset of the reference dataset without necessarily requiring an alignment of the two subsets. In this way, computation time and effort is reduced. In addition, alignment errors are prevented, which lead to a lot of false positive defect detections. On the other hand, this abstract representation allows for a broader and more flexible application of the defect detection method to imaging datasets and reference datasets of different appearance in the image space, e.g., in case of a different modality, different image statistics, a different image generation type or different alignment of the imaging dataset and the reference dataset.

According to an example, the dimension of the feature space is lower than the dimension of the subset of the imaging dataset. By using a lower-dimensional feature space, the comparison of the input representation and the reference representation in the feature space can be carried out faster. Thus, the runtime of the defect detection method is reduced and the throughput increased. Secondly, the feature space only preserves the most relevant information of the imaging dataset and the reference dataset due to the lower dimension. For example, noise or redundant information is reduced in this way. Thus, the accuracy and robustness of the defect detection method is improved.

According to an example, the feature space is defined depending on meta information concerning the imaging dataset and/or the reference dataset and/or the integrated circuit patterns of the object and/or the defects and/or the location of the subset of the imaging dataset. Different feature spaces can, thus, be defined with respect to the specific defect detection problem, e.g., a different feature space can be used for logic structures and for memory structures, or for locations at the border of the imaging dataset and for locations in the center of the imaging dataset, or for different sizes of critical dimensions or expected defects. In this way, feature spaces can be re-used depending on the specific circumstances of the defect detection task.

According to an example, the appearance of the imaging dataset differs from the appearance of the reference dataset, wherein the appearance comprises at least one aspect from the group containing image statistics, image modality, image generation type, image alignment.

Image statistic variations can, for example, occur due to the use of different image acquisition apparatuses, due to the use of different objects or due to the use of the same image acquisition apparatus but at different points in time. Image statistics comprise variations in, e.g., brightness, contrast, colors, noise level, sharpness, depth of field, focus, resolution, location, alignment, illumination, etc. The image modality can differ, if the imaging dataset and the reference dataset are obtained using different types of image acquisition apparatuses, e.g., scanning electron microscopes (SEM), focused ion beam (FIB) microscopes, atomic force microscopes (AFM), aerial image measurement systems, e.g., equipped with a staring array sensor or a line-scanning sensor or a time-delayed integration (TDI) sensor, Xray, etc. The image generation type refers to the way the images are generated, e.g., by image acquisition or artificially, for example using a model design such as a CAD file. The image alignment refers to the alignment of the imaging dataset and the reference dataset with respect to each other or to some fixed location.

If the appearance of the imaging dataset and the appearance of the reference dataset do not differ, the input machine learning model and the reference machine learning model can be identical. Thus, the input machine learning model can be used as input machine learning model and as reference machine learning model. In this way, only one machine learning model has to be trained, thus reducing the required user effort and the required amount of training data.

If the appearance of the imaging dataset differs from the appearance of the reference dataset, a direct comparison of the subset of the imaging dataset and the subset of the reference dataset in the image space is not possible. According to the invention, two solutions are provided in this situation. Firstly, the appearance of one of the datasets is modified to imitate the appearance of the other dataset. In this case, the input machine learning model and the reference machine learning model can be identical after modifying the appearance of one of the datasets. Secondly, a joint feature space is obtained, such that the input representation and the reference representation can be compared in the joint feature space. Both approaches can also be combined. In this way, defects can be detected in the subset of the imaging dataset independent of the appearance of the imaging dataset and the reference dataset. Thus, the applicability of the defect detection method is extended, e.g., to imaging datasets and reference datasets acquired by different machines, at different points in time or using different objects.

According to an example, the appearance of the reference dataset is modified to imitate the appearance of the imaging dataset, or the appearance of the imaging dataset is modified to imitate the appearance of the reference dataset. This can be accomplished using, for example, trained image-to-image machine learning models, which learn to map an image of a first appearance to the same image of a second appearance, thereby modifying the appearance of the image without modifying the information contained in the image (e.g., by modifying the brightness, contrast or noise level of the image). In this way, the defect detection method can be applied to imaging datasets and reference datasets of different appearances. At the same time, the input machine learning model and the reference machine learning model can be identical, since the input to both machine learning models are of the same appearance. Thus, memory space is saved. In addition, the user effort for training the machine learning models is reduced.

According to another example, generating the input representation in the feature space comprises applying a trained input machine learning model to the subset of the imaging dataset, and generating the reference representation in the feature space comprises applying a trained reference machine learning model to the subset of the reference dataset. The input machine learning model, thus, maps the subset of the imaging dataset to the feature space, and the reference machine learning model maps the corresponding subset of the reference dataset to the feature space. By applying machine learning models, the most relevant information for defect detection can be automatically extracted from the subset of the imaging dataset and from the subset of the reference dataset. This is because machine learning models directly learn from huge amounts of training data by minimizing some kind of loss function instead of relying on suboptimal rules or values defined by humans. Thus, the accuracy of the defect detection method is improved. Furthermore, training an input machine learning model and a different reference machine learning model allows for the accommodation of imaging datasets and reference datasets of differing appearance, since the input machine learning model and the reference machine learning model both map their inputs to the same feature space. The comparison can then be carried out in this feature space independent of the underlying appearances of the imaging dataset and the reference dataset. Thus, the applicability of the defect detection method is extended.

According to an aspect, the input machine learning model is trained to reconstruct the subset of the imaging dataset and/or the reference machine learning model is trained to reconstruct the subset of the reference dataset. This aspect relies on the concept that defects in the subset of the imaging dataset can be found by comparing the subset of the imaging dataset to its reconstruction obtained by using a machine learning model, which is trained to reconstruct the imaging dataset using a corresponding loss function during training. The machine learning model is trained on predominantly defect-free imaging datasets. Predominantly defect-free means that less than 10%, preferably less than 5%, of the training images contain a defect. Such a machine learning model can, for example, comprise an autoencoder or an inpainting machine learning model. By training a machine learning model for reconstruction tasks, the feature space is specifically adapted to the defect detection task, thereby improving the accuracy of the defect detection method.

The input machine learning model can comprise an input neural network and the reference machine learning model can comprise a reference neural network, and the feature space can comprise activations of one or more layers of the input neural network and activations of one or more layers of the reference neural network. By using neural networks, activations of layers of these neural networks can be used as feature space. An activation of a layer of a neural network comprises activations of all neurons of the layer. An activation a of a neuron refers to the result of a function f that calculates the output of the neuron based on its individual inputs xᵢ and their weights wᵢ, e.g.,

$$a = f ( {\sum }_{i = 1}^{n} {w}_{i} {x}_{i} )$$

The function f can, for example, be a ReLU function or a sigmoid function, etc.

The one or more layers of the input neural network and the one of more layers of the reference neural network define the feature space, since the one or more layers of the input neural network (together with the preceding layers) and the one or more layers of the reference neural network (together with the preceding layers) define a mapping into the feature space for a given subset of the imaging dataset and a corresponding subset of the reference dataset. Since the neural networks are trained using training data, the feature space defined by activations of layers of the neural networks are automatically optimized with respect to the loss function (e.g., a loss function for image reconstruction). Thus, the accuracy of the defect detection method is improved, and the feature space can be obtained automatically without requiring expert knowledge of the user.

According to an example, the input neural network and the reference neural network have a sequence of at least one intermediate layer in common. Intermediate layers of a neural network comprise all layers of the neural network except for the first layer, the input layer, and their weights. The sequence of intermediate layers can comprise a single intermediate layer, two subsequent intermediate layers or multiple subsequent intermediate layers and their weights. As the input neural network and the reference neural network have at least one intermediate layer in common, the activations of the at least one common layer can be used as a joint feature space. The input neural network, thus, comprises a mapping of the subset of the imaging dataset to the activations of the at least one common layer, and the reference neural network comprises a mapping of the subset of the reference dataset to the activations of the at least one common layer. Due to the different sequences of layers preceding the common sequence, the input neural network and the reference neural network can map datasets of different appearances into the same feature space. Thus, the definition of the feature space can be accomplished automatically and data-driven, that is optimized with respect to the specific defect detection problem. There are different ways to configure neural networks to have a sequence of at least one intermediate layer in common.

According to a preferred embodiment of the invention, the architecture of the input neural network and the architecture of the reference neural network are configured such that the input neural network and the reference neural network share a sequence of at least one intermediate layer. Due to the shared sequence of at least one intermediate layer, the input neural network and the reference neural network are trained jointly. Thus, the weights of the at least one intermediate layer of the shared sequence are adapted to the subsets of the imaging dataset as well as to the corresponding subsets of the reference dataset. The input neural network from end to end can be trained to reconstruct the subset of the imaging dataset, and the reference neural network from end to end can be trained to reconstruct the corresponding subset of the reference dataset.

According to another preferred embodiment of the invention, the input neural network and the reference neural network comprise an identical sequence of at least one intermediate layer. In this case, the input neural network and the reference neural network do not share a sequence of intermediate layers, but one has an exact copy of a sequence of the other. Training of the input neural network and the reference neural network can be accomplished using weight coupling. Thus, the weights of the at least one intermediate layer of the identical sequences are adapted to the subsets of the imaging dataset as well as to the corresponding subsets of the reference dataset. The input neural network from end to end can be trained to reconstruct the subset of the imaging dataset, and the reference neural network from end to end can be trained to reconstruct the corresponding subset of the reference dataset.

According to an aspect, the feature space comprises activations of one or more of the at least one intermediate layer of the common sequence. The input representation of the subset of the imaging dataset in the feature space, thus, comprises the activation of the one or more of the at least one intermediate layer of the common sequence when applying the input neural network to the subset of the imaging dataset, and the reference representation of the subset of the reference dataset comprises the activation of the one or more of the at least one intermediate layer of the common sequence when applying the reference neural network to the subset of the reference dataset. In this way, the feature space as well as the input representations and the reference representations in the feature space are automatically generated in a data-driven manner and, thus, optimal with respect to some loss function and the specific defect detection problem. Thus, the accuracy of the defect detection method is improved. At the same time, the applicability of the defect detection method to imaging datasets and reference datasets of different appearances is made possible. Finally, the user effort and expert knowledge required for generating the feature space is reduced, since the joint feature space is automatically derived from training data and does not have to be defined by an expert user.

According to an example, the input neural network and the reference neural network each contain a sequence comprising the same number of one or more corresponding intermediate aligned layers. These corresponding one or more intermediate aligned layers define the feature space. Two corresponding intermediate layers are aligned if the size of the activations of the layers is identical and if the corresponding layers generate similar activations when presenting a defect-free subset of the imaging dataset to the input neural network and a corresponding subset of the reference dataset to the reference neural network. The corresponding intermediate aligned layers in the sequence do not have to be consecutive. Having corresponding intermediate aligned layers that define the feature space simplifies training.

According to an example, the input neural network and the reference neural network each contain a sequence comprising the same number of one or more corresponding, structurally identical intermediate layers. These corresponding one or more intermediate layers define the feature space. Structurally identical means that the structure of corresponding intermediate layers is identical, the structure comprising all parameters of the layers that are not learned from training data such as the size of the layer, the number of neurons, the size of the input of the neurons, the size of the output of the neurons, a type of activation function of the neurons, etc. The corresponding structurally identical intermediate layers do not have to be consecutive. Having structurally identical corresponding intermediate layers that define the feature space simplifies training.

According to an aspect, each two corresponding intermediate layers of the sequences are aligned. Two layers are aligned if they produce at least similar activations, when presenting a defect-free subset of the imaging dataset to the input neural network and a corresponding subset of the reference dataset to the reference neural network. Similar activations means that the values of the activations differ by less than 20%, preferably less than 10%. Corresponding aligned intermediate layers can be structurally identical, but they do not have to be. It suffices if the activations of corresponding aligned intermediate layers are of the same size. Similar activations in the feature space for a defect-free subset of the imaging dataset and a corresponding subset of the reference dataset can be achieved by using additional alignment loss terms in the loss function that penalize deviations of activations in corresponding layers. In this way, the input neural network and the reference neural network are coupled without using shared or identical layers to define the feature space. Thus, the mapping to the feature space is more flexible and can differ in the input neural network and the reference neural network and, therefore, be optimally adapted to different appearances of the imaging dataset and the reference dataset. Intermediate layers of the input neural network and the reference neural network can be aligned using a specific loss function during training.

According to an example, a computer implemented method for training an input machine learning model and/or a reference machine learning model according to the aspect described before comprises minimizing a loss function comprising an alignment loss that penalizes the deviation of each activation of an intermediate layer of the sequence of one or more layers of the input neural network from the activation of the corresponding intermediate layer of the sequence of the one or more layers of the reference neural network, when presenting a defect-free subset of the imaging dataset to the input neural network and a corresponding subset of the reference dataset to the reference neural network. An alignment loss measures the deviation between the activations of two layers.

The input neural network and the reference neural network can be trained jointly or sequentially. Joint training is faster because it requires just one training run as opposed to two sequential runs in case of sequential training. However, sequential training can be more stable, as there is only one objective to be optimized at a time. In addition, a different task with more available training data could be used for pre-training the input neural network in the sequential setup, providing a stronger base model and a more descriptive feature space. This includes self-supervised pre-training on unlabeled data.

According to a preferred embodiment of the invention, the input neural network and the reference neural network comprise an autoencoder. Autoencoders are well suited for the reconstruction task and, thus, for defect detection, since they learn to accurately reconstruct the input dataset without defects when trained on predominantly defect-free data. Thus, the accuracy of the defect detection method is improved.

In particular, the encoder of the autoencoder of the input neural network and the encoder of the autoencoder of the reference neural network can have a sequence of at least one intermediate layer in common. In this way, the runtime of the defect detection method is reduced, since the subset of the imaging dataset and the subset of the reference dataset do not have to be reconstructed by the respective autoencoder, which is time consuming. Instead, the activation of one or more of the at least one intermediate layers in the respective encoder can be used as feature space. Thus, the mapping of the subset of the imaging dataset and the subset of the reference dataset to the feature space can be computed quickly. The earlier the common sequence is located in the respective encoders, the less computation time is required for the mapping into the feature space.

Alternatively, the common sequence of the input neural network and the reference neural network can be located in the decoder of the input neural network and the reference neural network. In another alternative, the common sequence can comprise layers of the encoder and the decoder including the bottleneck of the input neural network and the reference neural network. The earlier the common sequence is located in the input neural network and the reference neural network, the less computation time is required for the mapping into the feature space.

In a preferred embodiment, the common sequence of at least one intermediate layer comprises the bottleneck of the autoencoder. In particular, the feature space is defined by one of the at least one intermediate layers preceding the bottleneck, for example by the intermediate layer directly preceding the bottleneck. Alternatively, the feature space can be defined by the bottleneck of the autoencoders. By using an intermediate layer close to the bottleneck or the bottleneck itself for the definition of the feature space, all relevant information for defect detection is contained in the feature space in a compressed form and, thus, the accuracy of the defect detection method is improved.

According to an example, the input machine learning model and the reference machine learning model are loaded from a memory or database depending on meta information concerning the imaging dataset and/or the reference dataset and/or the integrated circuit patterns of the object and/or the defects and/or the input machine learning model and/or the reference machine learning model. The input machine learning model and the reference machine learning model can be saved to a memory or database after training and can be re-used for the same or similar defect detection tasks. Along with the input machine learning model and the reference machine learning model meta information can be stored, e.g., the type of structures of the integrated circuit patterns of the object (e.g., logical, memory, circular, pillars, etc.), the critical dimension of the structures, the expected defect size, the appearance of the imaging dataset (e.g., the modality, alignment or image generation type of the imaging dataset and the reference dataset), a quality indicator of the imaging dataset and/or the reference dataset (e.g., the noise level), parameters of the input neural network and/or the reference neural network (e.g., architecture parameters), image acquisition settings for acquiring the imaging dataset and/or the reference dataset, the location of the imaging dataset and/or the reference dataset within the imaging dataset or within the object, the timestamp indicating the time when the imaging dataset and/or the reference dataset were acquired, the timestamp indicating the time when the input neural network and/or the reference neural network were trained, the type of defects contained in the imaging dataset, an indicator if the reference machine learning model is identical to the input machine learning model, etc. Using this meta information, suitable pairs of input machine learning models and reference machine learning models can be selected from the memory or database for a new defect detection task. The loaded input machine learning model and reference machine learning model can be used as is, or they can be used as pre-trained models and, thus, they can be adapted to the new defect detection task by training on additional training data. In this way, the applicability of the defect detection method is extended, and the user effort is reduced.

In an example, the input machine learning model is trained to map the subset of the imaging dataset to an output space, and the reference machine learning model is trained to map the subset of the reference dataset to the same output space, e.g., to an image space, to a design space or to a vector space indicating a classification, etc. Using the same output space simplifies training. In addition, the appearance of the subset of the imaging dataset and the appearance of the subset of the reference dataset can be harmonized. Alternatively, the input machine learning model and the reference machine learning model could be trained to map to different output spaces, e.g., to an image space and to a design space.

To detect defects in the feature space, various methods can be applied. In an example, detecting defects comprises computing a distance measure between the input representation and the reference representation in the feature space. The distance measure can, for example, comprise a norm of a difference vector in case the input representation and the reference representation comprise feature vectors. The distance measure can, for example, comprise a measurement for the similarity of two probability distributions, e.g., a Kullback-Leibler divergence, in case the input representation and the reference representation comprise probability distributions in the feature space. Other distance measures are conceivable. The distance measure can be mapped to a different resolution, e.g., to the resolution of the subset of the imaging dataset. In this way, the defects can be localized in the subset of the imaging dataset.

Alternatively, detecting defects can comprise applying a trained machine learning model to the input representation and the reference representation in the feature space or to a function of the input representation and the reference representation in the feature space. The function can, for example, comprise a difference measure of the input representation and the reference representation, e.g., a difference vector, a norm of a difference vector, or some other kind of function such as an exponential or logarithmic function or a power function. The machine learning model can comprise an unsupervised machine learning model, a supervised machine learning model or a semi-supervised machine learning model. The machine learning model can be trained on pairs of an input representation and a corresponding reference representation in the feature space, or it can be trained on difference measures of the input representation and the corresponding reference representation in the feature space, e.g., on difference vectors or Kullback-Leibler divergences. The subset of the imaging dataset and/or the subset of the reference dataset can be provided to the machine learning model as additional input data. In an example, the machine learning model comprises a one class support vector machine (SVM) trained on a difference measure of defect-free input representations and corresponding reference representations. In another example, the machine learning model is trained in a supervised manner using labels indicating “defect/no defect” or a pixel wise segmentation of the defect in the subset of the imaging dataset. By using machine learning models, the defect detection in the feature space can be obtained automatically and optimally with respect to some loss function. In addition, expert knowledge on rules for how to detect defects is not required.

In an example, the method for defect detection in an object comprising integrated circuit patterns further comprises classifying one or more of the detected defects by applying a defect classification method to the input representation in the feature space. The reference representation in the feature space can be used as additional input to the defect classification method. For example, defect classification can be carried out by training another machine learning model on input representations and corresponding defect types, e.g., an SVM, a random forest or a neural network.

Another embodiment of the invention involves a computer implemented method for training an input machine learning model and/or a reference machine learning model for defect detection as described herein.

A further embodiment of the invention involves a computer-readable medium, on which a computer program executable by a computing device is stored, the computer program comprising code for executing a method for defect detection in an object comprising integrated circuit patterns as described herein.

Another embodiment of the invention concerns a computer program product comprising instructions which, when the program is executed by a computer, cause the computer to carry out a method for defect detection in an object comprising integrated circuit patterns as described herein.

According to another embodiment of the invention, a system for defect detection in an object comprising integrated circuit patterns comprises: an imaging device configured to provide an imaging dataset of the object comprising integrated circuit patterns; one or more processing devices; and one or more machine-readable hardware storage devices comprising instructions that are executable by one or more processing devices to perform operations comprising any one of the methods for defect detection in an object comprising integrated circuit patterns as described herein.

The invention described by examples and embodiments is not limited to the embodiments and examples but can be implemented by those skilled in the art by various combinations or modifications thereof.

### BRIEF DESCRIPTION OF DRAWINGS

FIG. 1 illustrates an exemplary transmission-based photolithography system, e.g., a deep ultraviolet (DUV) photolithography system;

FIG. 2 illustrates an exemplary reflection-based photolithography system, e.g., an extreme ultraviolet (EUV) photolithography system;

FIG. 3 shows an imaging dataset of an object comprising integrated circuit patterns in the form of a photolithography mask comprising a defect;

FIG. 4 illustrates a flowchart of a computer implemented method for defect detection in an object comprising integrated circuit patterns according to an embodiment of the invention;

FIG. 5 illustrates an example of the steps of the computer implemented method for defect detection in an object comprising integrated circuit patterns according to an embodiment of the invention;

FIG. 6 illustrates the modification of the appearance of the reference dataset to imitate the appearance of the imaging dataset by use of an appearance modifying machine learning model;

FIG. 7 illustrates a preferred embodiment of the invention to handle different appearances of the imaging dataset and the reference dataset by configuring the input neural network and the reference neural network to share a sequence of at least one intermediate layer;

FIG. 8 illustrates a preferred embodiment of the invention to handle different appearances of the imaging dataset and the reference dataset by configuring the input neural network and the reference neural network to have an identical sequence of at least one intermediate layer;

FIG. 9 illustrates a preferred embodiment of the invention to handle different appearances of the imaging dataset and the reference dataset by aligning a sequence of one or more intermediate layers of the input neural network and a sequence of one or more corresponding aligned intermediate layers of the reference neural network;

FIG. 10 shows defect detection results using different defect detection methods in the feature space for an imaging dataset and a reference dataset;

FIG. 11 shows a comparison of a defective subset of an imaging dataset and a corresponding subset of a reference dataset in feature space; and

FIG. 12 illustrates a system for defect detection in an object comprising integrated circuit patterns according to an embodiment of the invention.

### DETAILED DESCRIPTION

In the following, advantageous exemplary embodiments of the invention are described and schematically shown in the figures. Throughout the figures and the description, same reference numbers are used to describe same features or components. Dashed lines indicate optional features.

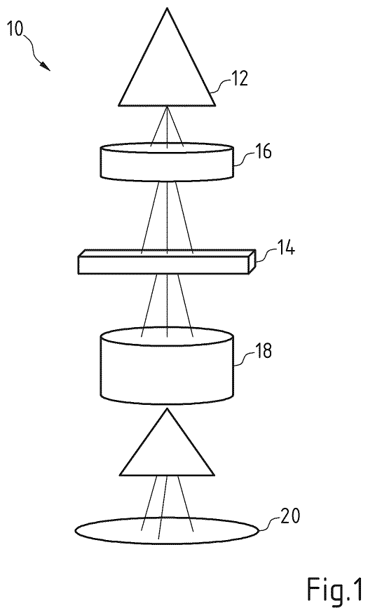

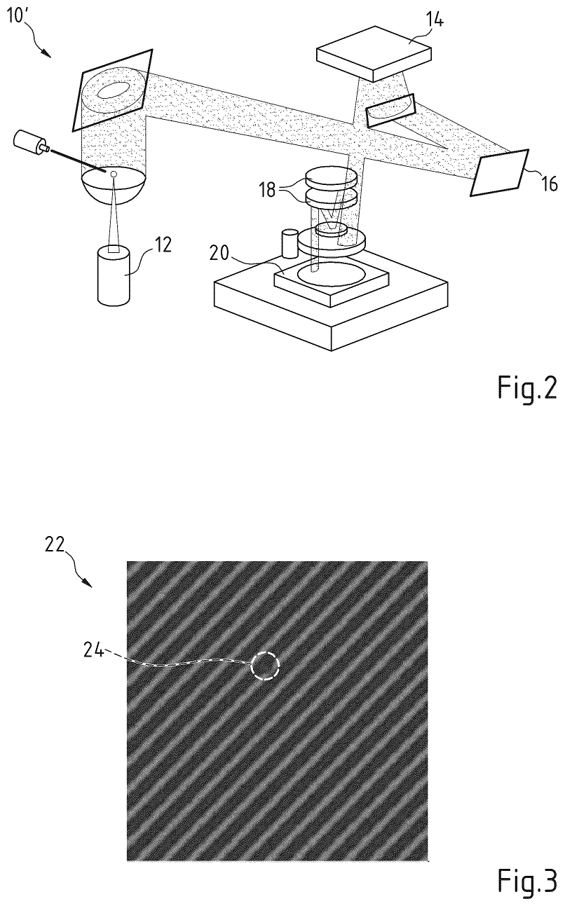

The methods described herein can be used, for example, with transmission-based photolithography systems 10 or reflection-based photolithography systems 10′ as shown in FIGS. 1 and 2.

FIG. 1 illustrates an exemplary transmission-based photolithography system 10, e.g., a DUV photolithography system. Major components are a light source 12, which may be a deep-ultraviolet (DUV) excimer laser source, imaging optics which, for example, define the partial coherence and which may include optics that shape radiation from the light source 12, a photolithography mask 14, illumination optics 16 that illuminate the photolithography mask 14 and projection optics 18 that project an image of the photolithography mask pattern onto a photoresist layer of a wafer 20. An adjustable filter or aperture at the pupil plane of the projection optics 18 may restrict the range of beam angles that impinge on the wafer 20.

In the present document, the terms “radiation” or “beam” are used to encompass all types of electromagnetic radiation, including ultraviolet radiation (e.g., with a wavelengths of 365, 248, 193, 157 or 126 nm) and EUV (extreme ultra-violet radiation, e.g. having a wavelength in the range of about 3-100 nm).

Illumination optics 16 may include optical components for shaping, adjusting and/or projecting radiation from the light source 12 before the radiation passes the photolithography mask 14. Projection optics 18 may include optical components for shaping, adjusting and/or projecting the radiation after the radiation passes the photolithography mask 14. The illumination optics 16 exclude the light source 12, the projection optics exclude the photolithography mask 14.

Illumination optics 16 and projection optics 18 may comprise various types of optical systems, including refractive optics, reflective optics, apertures and catadioptric optics, for example. Illumination optics 16 and projection optics 18 may also include components operating according to any of these design types for directing, shaping or controlling the projection beam of radiation, collectively or singularly.

FIG. 2 illustrates an exemplary reflection-based photolithography system 10′, e.g., an extreme ultraviolet light (EUV) photolithography system 10′. Major components are a light source 12, which may be a laser plasma light source, illumination optics 16 which, for example, define the partial coherence and which may include optics that shape radiation from the light source 12, a photolithography mask 14, and projection optics 18 that project an image of the photolithography mask pattern onto a photoresist layer of a wafer 20. An adjustable filter or aperture at the pupil plane of the projection optics 18 may restrict the range of beam angles that impinge on the wafer 20.

The production of objects comprising integrated circuit patterns such as photolithography masks and wafers requires great care due to the small structure sizes of the integrated circuit patterns. Defects cannot be prevented but can lead to the malfunctioning of semiconductor devices. Therefore, an accurate and fast method for defect detection in objects comprising integrated circuit patterns is important.

FIG. 3 shows an imaging dataset 22 of an object comprising integrated circuit patterns in the form of a photolithography mask 14 comprising a defect 24. Methods known from the art often use die-to-die or die-to-database methods to detect such defects 24. Die-to-die methods compare a portion of the imaging dataset 22 to another portion of the same or a different imaging dataset 22 to detect defects 24. However, the applicability of die-to-die methods is limited, e.g., repeater defects cannot be discovered and suitable portions for comparison have to be found. In addition, they require the availability and time-consuming scanning of two corresponding portions of the object and exact knowledge about their relative position. Die-to-database methods allow for the detection of any defect 24 by providing a reference dataset that can be directly compared to an imaging dataset 22 of the object comprising integrated circuit patterns. However, the reference dataset must be generated or acquired, and the imaging dataset 22 and the reference dataset must be aligned before the comparison. Both is time-consuming and can lead to alignment errors, which in turn lead to many false positive defect detections. In addition, images usually contain a lot of redundant information, which makes it difficult to extract the relevant information for defect detection. Therefore, it is a feature of the invention to provide defect detection methods for objects comprising integrated circuit patterns with reduced computation time and improved accuracy and specificity.

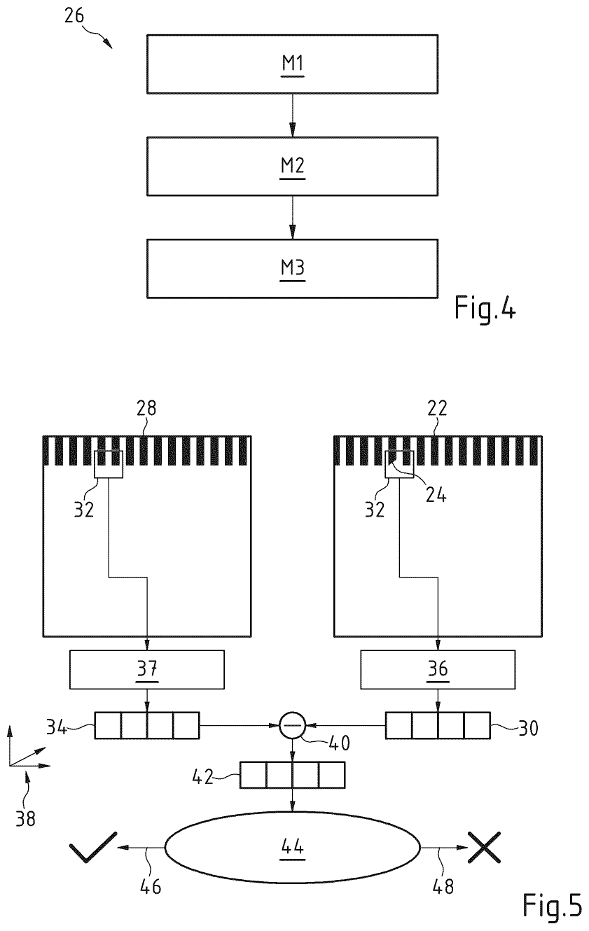

FIG. 4 illustrates a flowchart of a computer implemented method 26 for defect detection in an object comprising integrated circuit patterns according to an embodiment of the invention. The method comprises the following steps: obtaining an imaging dataset and a reference dataset of the object comprising integrated circuit patterns in a step M1; generating an input representation of a subset of the imaging dataset and a reference representation of the subset of the reference dataset in a feature space in a step M2; and detecting defects in the object comprising integrated circuit patterns by comparing the input representation to the reference representation in the feature space in a step M3.

By using a joint feature space for the input representation and the reference representation, the subset of the imaging dataset and the subset of the reference dataset can be compared quickly and with high accuracy. The feature space is preferably of lower dimensionality than the subset of the imaging dataset in order to reduce computation time and increase the throughput of the defect detection method. Preferably, the feature space is configured to preserve only the most relevant and meaningful information for defect detection in order to improve the accuracy of the defect detection method. Thus, by comparing the input representation and the reference representation in the feature space, defects can be detected faster and with improved accuracy compared to direct comparisons of the subset of the imaging dataset and of the subset of the reference dataset in the image space.

The imaging dataset 22 can comprise one or more images of one or more portions of the object comprising integrated circuit patterns or of the whole object. According to the techniques described herein, various imaging modalities may be used to acquire the imaging dataset 22 for the detection of defects 24. Imaging datasets 22 can comprise single-channel images or multi-channel images, e.g., focus stacks. For instance, it is possible that the imaging dataset 22 includes 2-D images. It is possible to employ a multi beam scanning electron microscope (mSEM). mSEM employs multiple beams to acquire contemporaneously images in multiple fields of view. For instance, a number of not less than 50 beams could be used or even not less than 90 beams. Each beam covers a separate portion of a surface of the object comprising integrated circuit patterns. Thereby, a large imaging dataset 22 is acquired within a short duration of time. Typically, 4.5 gigapixels are acquired per second. For illustration, one square centimeter of a wafer 20 can be imaged with 2 nm pixel size leading to 25 terapixel of data. Other examples for imaging datasets 22 including 2D images would relate to imaging modalities such as optical imaging, phase-contrast imaging, x-ray imaging, etc. It would also be possible that the imaging dataset is a volumetric 3-D dataset, which can be processed slice-by-slice or as a three-dimensional volume. Here, a crossbeam imaging device including a focused-ion beam (FIB) source, an atomic force microscope (AFM) or a scanning electron microscope (SEM) could be used. Multimodal imaging datasets may be used, e.g., a combination of x-ray imaging and SEM. The imaging dataset 22 can, additionally or alternatively, comprise aerial images acquired by an aerial imaging system. An aerial image is the radiation intensity distribution at substrate level. It can be used to simulate the radiation intensity distribution generated by a photolithography mask 14 during the photolithography process. The aerial image measurement system can, for example, be equipped with a staring array sensor or a line-scanning sensor or a time-delayed integration (TDI) sensor.

The reference dataset of the object comprising integrated circuit patterns can also be obtained in different ways. It can comprise an acquired imaging dataset or an artificially generated imaging dataset. In an example, the reference dataset is obtained by acquiring images of a reference object comprising integrated circuit patterns. The reference object comprising integrated circuit patterns can, for example, be another instance of the same type of object, or it can be of a different type but comprising at least a portion of the same integrated circuit patterns as the object. The reference dataset can be obtained from one or more portions of the (same) object comprising integrated circuit patterns, e.g., from another die of the object, for example in case of repetitive structures. Alternatively, the reference dataset can be artificially generated. In an example, the reference dataset is obtained from simulated images of the object comprising integrated circuit patterns, e.g., from CAD files or simulated aerial images. The simulated images can be loaded from a database or a memory or a cloud storage. The reference dataset is preferably predominantly defect-free, comprising none or only few defects (e.g., less than 10%, preferably less than 5% of the reference dataset comprises a defect).

FIG. 5 illustrates an example of the steps of the computer implemented method 26 for defect detection in an object comprising integrated circuit patterns according to an embodiment of the invention. A subset 32 of an imaging dataset 22 and a subset 32 of a reference dataset 28 are obtained. The subset of the imaging dataset 22 contains a defect 24. An input representation 30 of the subset 32 of the imaging dataset 22 is generated by mapping the subset 32 of the imaging dataset 22 into a feature space 38. A reference representation 34 of the subset 32 of the reference dataset 28 is generated by mapping the subset 32 of the reference dataset 28 into the feature space 38. The input representation 30 is compared to the reference representation 34 in the feature space 38 using a function 40 that yields a comparison result 42. The comparison result is a vector, which can be of the same length as the input representation 30 or the reference representation 34 or of a different length or of length 1. The function 40 can comprise any kind of calculation rule using the input representation 30 and the output representation 34. For example, the function can comprise the element-wise absolute difference of the input representation 30 and the reference representation 34, some other kind of norm of the element-wise difference of the input representation 30 and the reference representation 34, etc. The function can also comprise any other relation of the input representation 30 and the reference representation 34 apart from the difference. Then defects 24 are detected using a defect detection algorithm 44, which assigns the label “defect-free” 46 or “defective” 48 to the subset 32 of the imaging dataset 22. In addition, the defect 24 can be segmented from the subset 32 of the imaging dataset 22 to obtain a pixel wise representation of the defect 24. In addition, the defect 24 can be segmented from the subset 32 of the imaging dataset 22 to obtain a pixel wise representation of the defect 24.

A subset 32 of an imaging dataset 22 or a reference dataset 28 can comprise a section of arbitrary shape and size of the imaging dataset 22 or the reference dataset 28 respectively, e.g., a rectangular section of size 512×512 pixels, a circular section, patches of smaller size, etc., or the whole dataset.

The input representation 30 and the reference representation 34 in the feature space 38 can comprise vectors indicating coordinates in the feature space 38. The input representation 30 and the reference representation 34 can also comprise probability distributions in the feature space 38. Such probability distributions can, for example, be obtained by use of generative probabilistic models in machine learning, e.g., variational autoencoders. Probability distributions in the feature space 38 can, for example, be compared by use of the Kullback-Leibler divergence.

According to an example, the feature space 38 is defined with respect to meta information concerning the imaging dataset 22 and/or the reference dataset 28 and/or the integrated circuit patterns of the object and/or the defects 24 and/or the location of the subset 32 of the imaging dataset 22. In an example, the feature space 38 is defined with respect to the type of integrated circuit patterns of the object, e.g., a different feature space can be defined for logic structures and for memory structures, or for line structures and circular pillar structures. In another example, the feature space 38 is defined with respect to the critical dimension of the integrated circuit patterns in the imaging dataset 22. For smaller critical dimensions, a higher accuracy of the defect detection is required to find defects of smaller size than it is required for larger critical dimensions. In another example, the feature space 38 is defined with respect to the minimum size of relevant defects 24 to be detected in the imaging dataset 22. In another example, the feature space 38 is defined with respect to the appearance (e.g., the image statistics, modality, image generation type, alignment, etc.) of the imaging dataset 22 and/or the reference dataset. In another example, the feature space 38 is defined with respect to the quality of the imaging dataset 22, e.g., the noise level, or with respect to the image acquisition settings. In another example, the feature space 38 is defined with respect to the location of the subset 32 of the imaging dataset 22 within the imaging dataset 22 or within the object, e.g., different feature spaces 38 can be defined for the borders of the imaging dataset 22 and for the center of the imaging dataset 22, or for regions of the imaging dataset 22 comprising different types of integrated circuit patterns of the object, or for specifically important regions and less important regions or irrelevant regions of the imaging dataset 22 or of the object.

The feature space 38 can be obtained in various ways. In an example, the feature space 38 is selected by a user, e.g., by selecting a set of filters to be applied to the imaging dataset 22. In an example, the feature space 38 is obtained by applying feature extraction methods to the imaging dataset 22 and to the reference dataset 28. For example, a scale invariant feature transform (SIFT) feature space 38, a histogram of oriented gradients (HOG) feature space 38 or a filter response feature space 38, e.g., based on a set of Gabor filters, Sobel filters, frequency filters or edge detection filters, etc., can be defined. The subset 32 of the imaging dataset 22 and the subset 32 of the reference dataset 28 can be mapped into the feature space 38 by computing the corresponding type of features from the subset 32 of the imaging dataset 22 and from the subset 32 of the reference dataset 28, thereby obtaining an input representation 30 and a reference representation 34 in the feature space 38.

In a preferred embodiment, the feature space 38 is obtained by machine learning. According to an example, generating the input representation 30 in the feature space 38 comprises applying a trained input machine learning model 36 to the subset 32 of the imaging dataset 22, and generating the reference representation 34 in the feature space 38 comprises applying a trained reference machine learning model 37 to the subset 32 of the reference dataset 28, as shown in FIG. 5.

The input machine learning model 36 can be trained to reconstruct the imaging dataset 22, and the reference machine learning model 37 can be trained to reconstruct the reference dataset 28. Given an image, machine learning models for the reconstruction of this image are trained to reconstruct the image under some kind of additional constraints, e.g., dimensionality constraints, image-based constraints, target images etc. Machine learning models for the reconstruction of images comprise, for example, subspace models, autoencoder models, inpainting models and image-to-image models, etc. Subspace models and autoencoders reconstruct the image in a lower-dimensional subspace of the original image space. Inpainting models reconstruct the image by applying image-based constraints such as color, edge or pattern continuity, etc. Image-to-image models learn to map an image to a target image, e.g., an image comprising noise or defects to a noiseless or defect-free image. By using a machine learning model trained to reconstruct the input image, defects can be detected, as defects usually correspond to unexpected patterns in the image that cannot be reconstructed by the machine learning model.

The machine learning models can be trained in a supervised, semi-supervised or unsupervised manner. Unsupervised machine learning methods do not require any user input or annotations, they learn from training data by finding common concepts in the training data and clustering them. Unsupervised machine learning methods comprise, for example, clustering methods, principal component analysis (PCA), independent component analysis (ICA) or autoencoders. These methods are used to learn a subspace of the input data that preserves the most important information of the training data, while removing less relevant information or noise.

Supervised machine learning methods train machine learning models using labeled training data. Labeled training data, for example, comprises subsets 32 of imaging datasets 22 with labeled defects 24, e.g., by use of pixel annotations, bounding boxes or image-level annotations, etc. Machine learning methods trained in a supervised manner learn the mapping of the training data to the labels and generalize this knowledge to new input data. Supervised machine learning methods directly learn from the indicated labels, and can, thus, be used for any kind of task.

Semi-supervised machine learning methods use a small amount of labeled data and a large amount of unlabeled data, thus providing the benefits of both unsupervised and supervised learning while avoiding the challenges of finding a large amount of labeled data.

In an example, the input machine learning model 36 and the reference machine learning model 37 are pre-trained on some other dataset, e.g., ImageNet. The input machine learning model 36 and the reference machine learning model 37 can be used as is after training on the other dataset, or they can be refined using application specific training data.

According to an example, the input machine learning model 36 comprises an input neural network, and the reference machine learning model 37 comprises a reference neural network.

The input neural network 36 and the reference neural network 37 can be deep convolutional neural networks. A deep neural network consists of a large number of layers allowing it to process data in a complex way, using advanced mathematical models. A convolution refers to the application of a filter to an input that results in an activation of a neuron. A convolution neural network has the ability to automatically learn a large number of filters in parallel specific to a training dataset and a loss function. The learned filters are automatically derived and optimized with respect to the training dataset and the loss function.

According to an aspect of the example, the feature space 38 comprises activations of one or more layers of the input neural network and of one or more layers of the reference neural network. The input representation 30 of the subset 32 of the imaging dataset 22 in the feature space 38 then comprises the activation of the one or more layers of the input neural network when applied to the subset 32 of the imaging dataset 22, and the reference representation 34 of the subset 32 of the reference dataset 28 comprises the activation of the one or more layers of the reference neural network when applied to the subset 32 of the reference dataset 28.

The input machine learning model 36 and the reference machine learning model 37 can be identical or different. In case they are identical, the input machine learning model 36 is used as input machine learning model 36 and as reference machine learning model 37 such that only one machine learning model has to be trained for generating the input representation 30 and the reference representation 34 in the feature space 38. Thus, computation time is reduced. If the input machine learning model 36 differs from the reference machine learning model 37, the defect detection method is more flexible to incorporate imaging and reference datasets of different appearances, e.g., of different image statistics, image modalities, image generation methods or alignment.

In a preferred embodiment of the invention, the appearance of the imaging dataset 22 differs from the appearance of the reference dataset 28. The appearance comprises at least one aspect from the group containing image statistics, image modality, image generation type, image alignment. The appearance can comprise one, two, three or all of the aspects from the group.

For example, the imaging dataset 22 and the reference dataset 28 are obtained by the same image acquisition apparatus at different points in time. Due to slight variations in the image acquisition apparatus or the environment, the statistics of the imaging dataset 22 and the reference dataset 28 can differ, e.g., brightness, contrast, colors, sharpness, depth of field, focus, resolution, illumination, etc. In another example, the imaging dataset 22 and the reference dataset 28 are obtained by different image acquisition apparatuses, either simultaneously or at different points in time. The image acquisition apparatuses can be of the same type. In this case, the image statistics can differ due to small variations in the image acquisition apparatuses. In another example, the imaging dataset 22 and the reference dataset 28 are obtained by the same image acquisition apparatus but using different objects of the same type. Since the objects can vary slightly the image statistics can differ.

The image acquisition apparatuses can also be of a different type, for example, they can acquire images of different modality, e.g., scanning electron microscopy (SEM) images, focused ion beam (FIB) microscopy images, atomic force microscopy (AFM) images, aerial images obtained by a measurement system, e.g., equipped with a staring array sensor or a line-scanning sensor or a time-delayed integration (TDI) sensor, Xray images, etc. Furthermore, image acquisition apparatuses with different wavelengths can be used, e.g., in the visible spectrum between 400 and 750 nm, in the infrared (IR) spectrum larger than 750 nm, in the UV spectrum smaller than 400 nm, in the DUV spectrum, e.g., 193 nm, or in the EUV spectrum, e.g., 13.5 nm. For example, the imaging dataset can be obtained using a first image acquisition apparatus and the reference dataset can be obtained using a second image acquisition apparatus, or the imaging dataset and the reference dataset can be obtained using the same image acquisition apparatus but with different wavelengths, or the imaging dataset and the reference dataset can be obtained using the same imaging apparatus with the same wavelengths.

In another example, the imaging dataset 22 and the reference dataset 28 differ in the image generation type, i.e., in the way they are generated, for example, one of them can be acquired by some kind of image acquisition apparatus, while the other is generated artificially, e.g., by a computer model such as a CAD-model.

In case different image acquisition apparatuses, different objects or different points in time are used to acquire the imaging dataset 22 and the reference dataset 28, the imaging dataset 22 and the reference dataset 28 are, generally, not aligned.

Due to the differences in the appearance of the imaging dataset 22 and the reference dataset 28, the input representation 30 of the imaging dataset 22 in the feature space 38 would not be comparable to the reference representation 34 of the reference dataset 28 in the feature space 38 if the reference machine learning model 37 was identical to the input machine learning model 26. There are two options to handle this situation. According to the first option, one of the datasets is transformed to match the appearance of the other dataset. In this case, the input machine learning model 36 can be identical to the reference machine learning model 37. According to the second option, a different reference machine learning model 37 is trained to handle the different appearances of both datasets. In this case, the input machine learning model 36 differs from the reference machine learning model 37. In the following, both options will be described in detail.

In case of the first option, the appearance of the reference dataset 28 is modified to imitate the appearance of the imaging dataset 22, or the appearance of the imaging dataset 22 is modified to imitate the appearance of the reference dataset 28. The appearance of the respective dataset can be modified by applying a trained machine learning model to the respective dataset. The machine learning model can be trained, e.g., to modify image statistics such as the contrast or brightness of the input image, to modify the modality of the input image, to align the imaging dataset 22 and the reference dataset 28, to modify the image generation type, etc.

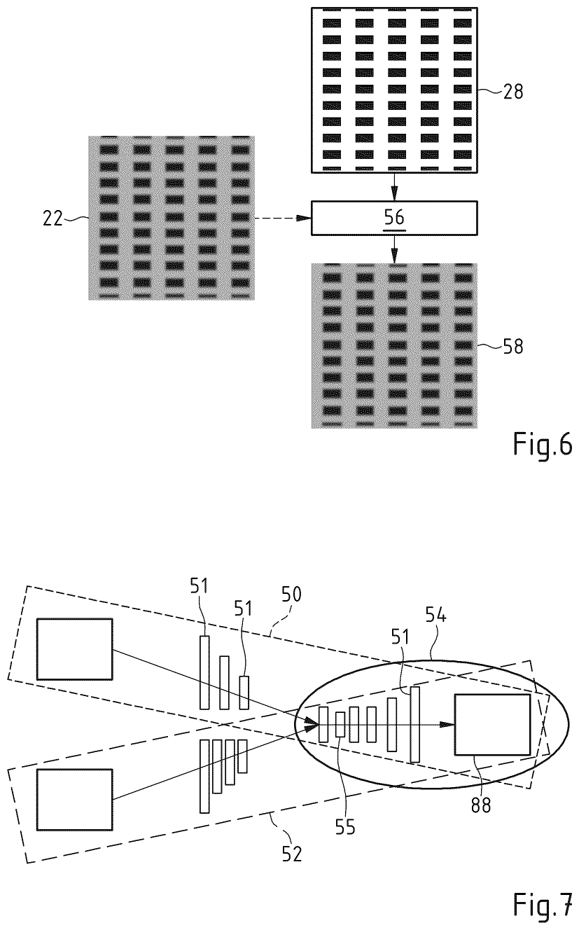

FIG. 6 illustrates the modification of the appearance of the reference dataset 28 to imitate the appearance of the imaging dataset 22 by use of an appearance modifying machine learning model 56. The imaging dataset 22 shows noisy regular memory structures acquired using an imaging apparatus, e.g., using a SEM. The reference dataset 28 shows a corresponding artificial regular memory structure obtained from a CAD model. The appearance modifying neural network 56 is trained using pairs of imaging datasets 22 of a first appearance (e.g., SEM images) and reference datasets 28 of a second appearance (e.g., corresponding images from a CAD model or an aerial image). The reference dataset 28 is used as input to the appearance modifying machine learning model 56. The appearance modifying machine learning model 56 is trained to modify the appearance of the reference dataset 28 to imitate the appearance of the imaging dataset 22, thereby yielding an appearance modified reference dataset 58. Correspondingly, an appearance modifying neural network 56 can be trained to modify the appearance of the imaging dataset 22 to imitate the appearance of the reference dataset 28.

Such an appearance modifying machine learning model 56 can, for example, be implemented by use of a generative adversarial neural network (GAN). GANs are generative models that learn a mapping from an observed image x and a random noise vector z to an output image y, GAN: {x, z}→y. The GAN contains a generator G and a discriminator D. During training, the discriminator D learns to discriminate between fake datasets, i.e., synthesized appearance modified reference datasets 58, and real datasets, i.e., imaging datasets 22. The generator G, on the other hand, learns to synthesize appearance modified reference datasets 58 that the discriminator D holds for real, that is for an imaging dataset 22. The loss function for the GAN can be written as

$${L}_{G A N} ( G , D ) = {E}_{y} [ log D ( y ) ] + {E}_{x , z} [ log ( 1 - D ( G ( x , z ) ) ) ] .$$

Here, the discriminator D maps to a probability distribution indicating the likelihood that the input image y is real and not synthesized by the generator.

Then the objective G* is obtained by optimizing

$${G}^{*} = arg {min}_{G} {max}_{D} {L}_{G A N} ( G , D ) .$$

Alternatively, a conditional GAN (cGAN) can be used. In a cGAN, the reference dataset 28 is an additional input to the discriminator D. The loss function for the cGAN can be written as

$${L}_{cGAN} ( G , D ) = {E}_{x , y} [ log D ( x , y ) ] + {E}_{x , z} [ log ( 1 - D ( x , G ( x , z ) ) ) ] .$$

Additional terms can be added to the loss functions, e.g., a distance of the imaging dataset 22 and the synthesized appearance modified reference dataset 58, e.g., an L₁ distance or an L₂ distance. During inference, the reference dataset 28 is presented to the generator G to obtain an appearance modified reference dataset 58.

According to the second option, a reference machine learning model 37 is trained, which is different from the input machine learning model 36, in order to handle the different appearances of the imaging dataset 22 and the reference dataset 28. To this end, the input machine learning model 36 comprises an input neural network and the reference machine learning model 37 comprises a reference neural network.

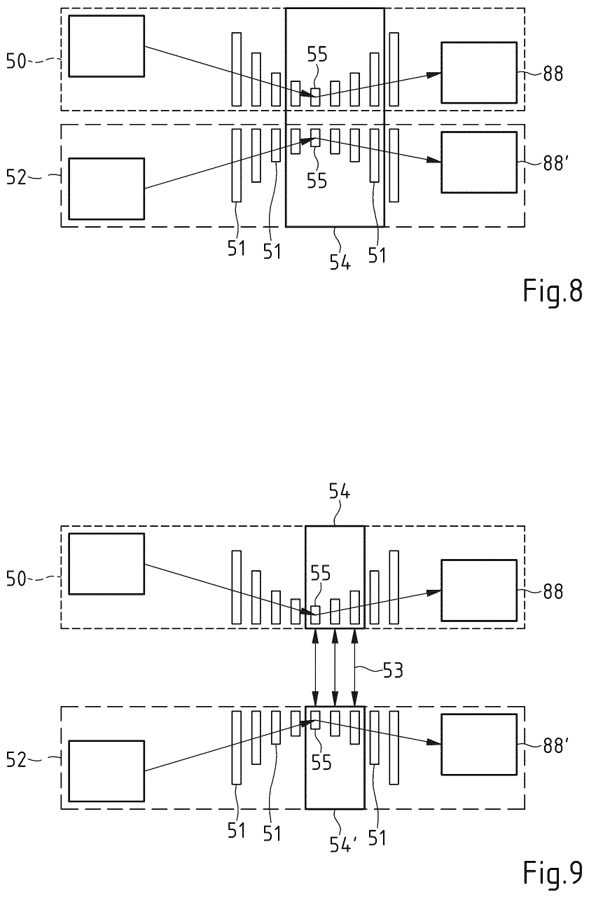

FIGS. 7, 8 and 9 illustrate preferred embodiments of the invention to handle different appearances of the imaging dataset 22 and the reference dataset 28. In FIGS. 7 and 8, the input neural network 50 and the reference neural network 52 have a sequence 54 of intermediate layers 51 in common. In FIG. 9, sequences 54, 54′ comprising one or more intermediate layers 51 of the input neural network 50 and the reference neural network 52 are aligned such that they produce similar activations in case of a defect-free subset of the imaging dataset being used as input to the input neural network 50 and a corresponding subset of the reference dataset being used as input to the reference neural network 52. By having a sequence 54 of intermediate layers 51 in common or by aligning sequences 54, 54′ of intermediate layers 51, the definition of a joint feature space 38 is possible even if the appearance of the imaging dataset 22 differs from the appearance of the reference dataset 28. In all of these embodiments, the sequence of intermediate layers can comprise consecutive layers or non-consecutive layers.

In order to be able to compare the imaging dataset 22 to the reference dataset 28 despite different appearances, the invention uses a joint feature space 38 within which the feature vectors are comparable. The subset 32 of the imaging dataset 22 and the subset 32 of the reference dataset 28 are mapped to this joint feature space 38 yielding an input representation 30 and a reference representation 34. The deviation, e.g., the difference, between the input representation 30 and the reference representation 34 can be used as a defect indicator, i.e., if a defect is present or not. In order to localize defects in the subset 32 of the imaging dataset 22, the difference in feature space can be mapped back to the image space, it can be “decoded”.

The input neural network 50 and the reference neural network 52 can perform specific tasks such as image reconstruction, image translation, segmentation, classification, detection, etc. In an example, the input neural network 50 is trained to map the subset 32 of the imaging dataset 22 to an output space 88, and the reference neural network 52 is trained to map the subset 32 of the reference dataset 28 to the same output space 88. This simplifies training. Alternatively, the input neural network 50 and the reference neural network 52 can map to different output spaces 88, 88′.

For example, the input neural network 50 and the reference neural network 52 can be image-to-image neural networks that map a subset 32 of the imaging dataset 22 or, respectively, a subset 32 of the reference dataset 28 to an output space 88, 88′ in the form of an image space. For example, the input neural network 50 can reconstruct the subset 32 of the imaging dataset 22 in an imaging dataset space, e.g., in an image space, and the reference neural network 52 can reconstruct the subset 32 of the reference dataset 28 in a reference dataset space, e.g., in a design space in case the reference dataset 28 is a design. To this end, autoencoders can, for example, be used.

In an example, the input neural network 50 and the reference neural network 52 contain skip connections and are trained to reconstruct both, the subset 32 of the imaging dataset 22 and the subset 32 of the reference dataset 28. The skip connections are used to improve the accuracy of the reconstruction. To prevent the input neural network 50 and the reference neural network 52 from simply copying the input to the output using the skip connections, both networks are trained to reconstruct the subset 32 of the imaging dataset 22 and the subset 32 of the reference dataset 28.

Alternatively, the input neural network 50 and the reference neural network 52 can both map their inputs to the same output space 88, e.g., to an image space or to a design space. To this end, the loss function during training can comprise a term that penalizes their difference in the output space 88. In this way, the input neural network 50 and the reference neural network 52 can learn to map their inputs to outputs of the same appearance.

In an example, the input neural network 50 can reconstruct the subset 32 of the imaging dataset 22 in an image space, e.g., using an autoencoder, and the reference neural network 52 can map the subset 32 of the reference dataset 28 to the same image space, e.g., using an encoder decoder architecture neural network. In a parallel example, the input neural network 50 can map the subset 32 of the imaging dataset 22 to a design image in a design space, e.g., using an encoder decoder architecture neural network, and the reference neural network 52 can reconstruct the subset 32 of the reference dataset 28, e.g., using an autoencoder.

Alternatively, the input neural network 50 and/or the reference neural network 52 can be classification neural networks that map an input image to an output space 88, 88′ comprising class indicators, e.g., indicating if a defect is present or not or a vector indicating the presence of specific defect types.

The input neural network 50 and the reference neural network 52 can perform the same task or different tasks. Independent of the task they perform and even if they perform different tasks, one or more of their intermediate layers 51 can be used to define a joint feature space 38, within which the feature vectors are comparable. To this end, the one or more intermediate layers 51 are coupled in some way, e.g., by using identical or shared layers or by aligning layers as shown in the following.

Intermediate layers 51 of a neural network include all layers except for the input layer. The input neural network 50 and the reference neural network have a sequence of intermediate layers in common, if they either share the sequence 54, or if they comprise an identical sequence. The sequence 54 of intermediate layers 51 can comprise one, two or multiple subsequent layers.

In the preferred embodiment illustrated in FIG. 7, the architecture of the input neural network 50 and the architecture of the reference neural network 52 are configured such that the input neural network 50 and the reference neural network 52 share a sequence 54 of at least one intermediate layer 51. The input neural network 50 and the reference neural network 52 can be trained jointly in order to adapt the shared sequence 54 of at least one intermediate layer 51 to the subsets 32 of the imaging dataset 22 and to the corresponding subsets 32 of the reference dataset 28. The input neural network 50 and the reference neural network 52 can map to the same output space 88 as shown in FIG. 7. However, they can also map to difference output spaces 88, 88′ despite the shared sequence 54 of at least one intermediate layer 51, e.g., by adding separate intermediate layers 51 to the input neural network 50 and to the reference neural network 52 after the shared sequence 54.

In an example, the shared sequence 54 of the input neural network 50 and the reference neural network 52 includes the whole decoder, and the modality of the output corresponds to the modality of the imaging dataset 22. The input neural network 50 is first trained to reconstruct imaging datasets 22. After that, the weights of the at least one intermediate layer of the shared sequence 54 are fixed. In the reference neural network 52, only the encoder is trained to generate a matching imaging dataset 22 from the reference dataset 28, while the decoder remains fixed. The feature space 38 can then be determined to comprise the activations of one or more of the at least one intermediate layer of the shared sequence 54. Instead of training the input neural network 50 and the reference neural network 52 sequentially, the input neural network 50 and the reference neural network 52 can be trained jointly, e.g., simultaneously or alternatingly.

In an alternative example, the input neural network 50 and the reference neural network 52 are identical and, thus, the shared sequence 54 comprises all layers of the input neural network 50 and the reference neural network 52. The modality of the output corresponds to the modality of the imaging dataset 22. The network is trained using imaging datasets 22 and reference datasets 28 simultaneously as input images, preferably imaging datasets 22 and corresponding reference datasets 28 (e.g., design images). The loss function can be defined as a reconstruction loss function that evaluates the deviation of the output from the input image. In this way, the network learns to disregard the differences between the imaging dataset 22 and the reference dataset 28 and to map both to the same output. The outputs can then be used as feature vectors in the feature space 38.

In the preferred embodiment in FIG. 8, the input neural network 50 and the reference neural network 52 comprise an identical sequence 54 of intermediate layers 51. Two sequences 54 of intermediate layers 51 are identical if the architecture hyperparameters and the learnable parameters for these sequences are identical. The architecture hyperparameters include the number and the size of the layers, the type of layers, the convolution parameters, the type of connections between the layers, etc. The learnable parameters include the weights between the neurons of the layers of the sequences 54, which are learned from training data. The input neural network 50 and the reference neural network 52 can be trained jointly by coupling the weights of the layers of the sequence. The input neural network 50 and the reference neural network 52 can map to different output spaces 88, 88′ as shown in FIG. 8. However, they can also map to the same output space 88, e.g., by adding a term to the loss function during training that penalizes deviations of their outputs in the output space 88.

In an example, the input neural network 50 and the reference neural network 52 have a shared sequence 54 of encoder and decoder layers. The bottleneck 50 corresponds to the feature space. The input neural network 50 is trained to reconstruct the imaging dataset 22, the reference neural network 52 is trained to reconstruct the reference dataset 28. A reconstruction loss known to the person skilled in the art, e.g., mean squared error, mean absolute error, etc. can be used for the input neural network 50 and the reference neural network. The two losses can be summed up and propagated back through the network to optimize the weights during training.

According to an example, the feature space 38 comprises activations of one or more of the intermediate layers 51 of the common sequence 54. The input representation 30 of the subset 32 of the imaging dataset 22 in the feature space 38 then comprises the activation of the one or more intermediate layers 51 of the sequence 54 when applying the input neural network 50 to the subset 32 of the imaging dataset 22, and the reference representation 34 of the subset 32 of the reference dataset 28 comprises the activation of the one or more intermediate layers 51 of the sequence 54 when applying the reference neural network 52 to the subset 32 of the reference dataset 28. Since both the input neural network 50 and the reference neural network 52 have the sequence 54 of intermediate layers 51 in common, they map their input into the same feature space 38.

The earlier the one or more intermediate layers 51 defining the feature space 38 are located in the input neural network 50 and the reference neural network 52, the less computation time is required for defect detection, since the imaging dataset 22 and the reference dataset 28 only need to be processed by a section of the input neural network 50 and the reference neural network 52. In addition, the feature space 38 can have less dimensions than the imaging dataset 22 and the reference dataset 28. In this case, subsequent defect detection algorithms 44 require less computation time due to the lower dimensionality of the input representation 30 and the reference representation 34 in the feature space 38.

In the preferred embodiment illustrated in FIG. 9, the input neural network 50 and the reference neural network 52 each contain a sequence 54, 54′ comprising the same number of one or more corresponding aligned intermediate layers 51. Two corresponding intermediate layers are aligned if the size of the activations of the layers is identical and if the corresponding layers generate similar activations when presenting a defect-free subset of the imaging dataset to the input neural network and a corresponding subset of the reference dataset to the reference neural network.

The layers in the sequence do not have to be consecutive, i.e., there may be other layers between the sequence layers, wherein the other layers do not belong to the sequence. For example, let the input neural network contain layers A, B, X, Y, C and the reference neural network contains layers A′, B′, Z, C′. Then the sequence of corresponding aligned layers contains A, B, C of the input neural network and A′, B′, C′ of the reference neural network, whereas X, Y, Z are not part of the sequence.

The corresponding aligned intermediate layers can be structurally identical. Structurally identical means that the structure of corresponding intermediate layers is identical, the structure comprising all parameters of the layers that are not learned from training data such as the size of the layer, the number of neurons, a type of input and transfer function, etc.

The structure of a sequence 54 of at least one intermediate layer 51 of the input neural network 50 is identical to the structure of a sequence 54′ of at least one intermediate layer 51 of the reference neural network 52 such that each intermediate layer 51 of the sequence 54 of the input neural network 50 corresponds to a structurally identical intermediate layer 51 of the sequence 54′ of the reference neural network 52. The sequences 54, 54′, thus, contain the same number of structurally identical intermediate layers 51, and corresponding intermediate layers 51 of the two sequences 54, 54′ are of the same size, contain the same number of neurons, use the same type of activation and transfer function in the neurons, etc. The corresponding intermediate layers are aligned.

The corresponding one or more intermediate layers 51 define the feature space 38. In case of two or more corresponding intermediate layers 51 in the sequences 54, 54′, to map an input of the input neural network 50 to the feature space 38, the activations of the sequence 54 of intermediate layers 51 can be computed and, e.g., concatenated to obtain a feature vector in feature space 38. To map an input of the reference neural network 52 to the feature space 38, the activations of the sequence 54′ of intermediate layers 51 can be computed and, e.g., concatenated to obtain a feature vector in feature space 38. The two feature vectors can then be compared in the feature space 38. Alternatively, each intermediate layer 51 in the sequence 54, 54′ can map to a separate feature space, the feature vectors can be compared within each feature space separately and the comparison result can be concatenated.

The input neural network 50 and the reference neural network 52 can map to different output spaces 88, 88′ as shown in FIG. 9. For example, the input neural network 50 can map to an image space, whereas the reference neural network 52 can map to a design space. However, they can also map to the same output space 88, e.g., by adding a term in the loss function that penalizes deviations of their activations in the output space 88. In this way, the subset 32 of the imaging dataset 22 and the subset 32 of the reference dataset (in case of a design) could both be mapped to representations in design space, or the subset 32 of the imaging dataset 22 and the subset of the reference dataset 28 could both be mapped to representations in image space.

As shown in FIG. 9, each two corresponding intermediate layers 51 of the sequences 54, 54′ are aligned 53, such that the activations of corresponding intermediate layers are of the same size and produce at least similar activations, when presenting a defect-free subset of the imaging dataset to the input neural network 50 and a corresponding subset of the reference dataset to the reference neural network 52. Thus, learned parameters, e.g., the weights, of the sequence 54 of intermediate layers 51 of the input neural network 50 and learned parameters of the sequence 54′ of corresponding intermediate layers 51 of the reference neural network 52 are configured such that the activation of each of the intermediate layers 51 in the sequence 54 of the input neural network 50 in the feature space 38 is at least similar to the activation of the corresponding intermediate layer 51 in the sequence 54′ of the reference neural network 52 in the feature space 38, when presenting a defect-free subset 32 of the imaging dataset 30 to the input neural network 50 and a corresponding subset 32 of the reference dataset 28 to the reference neural network 52. Thus, the intermediate layers 51 of the sequence 54 of the input neural network 50 and the corresponding intermediate layers 51 of the sequence 54′ of the reference neural network 52 are aligned 53.

By aligning intermediate layers 51, a joined feature space 38 can be created without sharing layers or using identical layers. Instead, sequences of aligned corresponding intermediate layers 51 are used. Thus, the mapping to the joined feature space is more flexible and does not have to be identical in the input neural network and the reference neural network. The one or more corresponding intermediate layers 51 are only structurally identical, and they are coupled to generate similar activations for corresponding inputs of the imaging dataset and the reference dataset, i.e., for defect-free subsets of the imaging dataset and corresponding subsets of the reference dataset. Thus, corresponding inputs lead to similar activations in the feature space 38. Non-corresponding inputs, e.g., a defective subset of the imaging dataset and a corresponding subset of the reference dataset or a subset of the imaging dataset and a non-corresponding subset of the reference dataset (e.g., subsets referring to different mask locations or structures), lead to dissimilar activations in the feature space 38. In order to align layers of two neural networks, a specific loss function can be used described in the following.

A computer implemented method for training an input machine learning model 50 and/or a reference machine learning model 52 according to the aspect described before comprises minimizing a loss function comprising an alignment loss that penalizes the deviation of each activation of an intermediate layer 51 of the sequence 54 of one or more layers of the input neural network 50 from the activation of the corresponding intermediate layer 51 of the sequence 54′ of the one or more intermediate layers 51 of the reference neural network 52, when presenting a defect-free subset 32 of the imaging dataset 30 to the input neural network 50 and a corresponding subset 32 of the reference dataset 28 to the reference neural network 52. An alignment loss measures the deviation between the activations of two layers. It can, for example, comprise some kind of norm between the differences of activations of corresponding layers, e.g., an L2-norm, an L1-norm, a cosine distance, etc. In case the sequences 54, 54′ contain more than one intermediate layer 51, an alignment loss between activations of each two corresponding intermediate layers can be defined and the sum of all of these alignment losses is added to the loss function.

The input neural network 50 and the reference neural network 52 can be trained jointly or sequentially. In case they are trained jointly, the parameters of the input neural network 50 and the reference neural network 52 are updated alternatingly or simultaneously within the same training step. In case they are trained sequentially, one of the networks is fully trained first and the other is trained afterwards. In this case, the one or more alignment losses are only used when training the second neural network in order to couple the parameters of the intermediate layers 51 of the sequence 54, 54′ of the second neural network to the parameters of the corresponding intermediate layers 51 of the sequence 54, 54′ of the first neural network.

In an example, the input neural network 50 and the reference neural network 52 comprise an autoencoder, in particular a variational autoencoder.

An autoencoder is a type of artificial neural network used in unsupervised learning to learn efficient representations of unlabeled data. Autoencoders learn the expected statistical variation of predominantly defect-free observed training data. An autoencoder comprises two main parts: an encoder that maps the training data into a code at the so-called bottleneck, and a decoder that maps the code to a reconstruction of the training data. The encoder neural network and the decoder neural network can be trained to minimize a difference between the reconstructed representation of the training data and the training data itself. The code typically is a representation of the training data with lower dimensionality and can, thus, be viewed as a compressed version of the training data. For this reason, autoencoders are forced to reconstruct the training data approximately, preserving only the most relevant aspects of the training data in the reconstruction.

Therefore, autoencoders can be used for the detection of defects 24. Defects 24 generally concern rare deviations from the norm. Due to the rarity of their occurrence the autoencoder will not reconstruct this kind of information, thus suppressing defects 24 in the reconstruction. Defects 24 can then be detected by comparing the imperfect reconstruction of the input data to the original input data of the trained autoencoder. The larger the difference between a reconstructed input data and the original input data, the more likely the input data comprises a defect 24.

A variational autoencoder is a probabilistic generative model that transforms an input image to a probability distribution over output images. It contains an encoder neural network and a decoder neural network. The encoder neural network maps the input variable to a latent space that corresponds to the parameters of a variational distribution. In this way, the encoder can produce multiple different samples that all come from the same distribution. The decoder has the opposite function, which is to map from the latent space to a probability distribution in the input space. Both networks are typically trained together exploiting a reparameterization technique. By using a variational autoencoder, the input representation 30 of the imaging dataset 22 contains a probability distribution in the latent space (feature space 38), and the reference representation 34 of the reference dataset 28 contains a probability distribution in the latent space (feature space 38). The probability distributions can then be compared to detect defects 24.

In an example, the encoder of the autoencoder of the input neural network 50 and the encoder of the autoencoder of the reference neural network 52 have a sequence of at least one intermediate layer 51 in common. Additionally or alternatively, the decoder of the input neural network 50 and the decoder of the reference neural network 52 can have a sequence of at least one intermediate layer 51 in common. The feature space 38 can then be defined as the activations of one or more of the intermediate layers 51 of the sequence 54, e.g., the activations of a layer before the bottleneck 55 or of the bottleneck 55 itself. The earlier the one or more intermediate layers 51 defining the feature space 38 are located in the architectures of the autoencoders, the less computation time is required for computing the input representation 30 of the imaging dataset 22 and the reference representation 34 of the reference dataset 28 in the feature space 38. Due to the lower dimensionality of the input representation 30 and the reference representation 34 subsequent defect detection algorithms 44 also require less computation time.

Since the input representation 30 and the reference representation 34 lie in the same feature space 38 they can be compared in the feature space 38—even if the imaging dataset 22 and the reference dataset 28 do not have the same appearance.

In an example, the input machine learning model 36 and the reference machine learning model 37 are loaded from a memory or database depending on meta information concerning the imaging dataset 22 and/or the reference dataset 28 and/or the integrated circuit patterns of the object and/or the defects 24 and/or the input machine learning model 36 and/or the reference machine learning model 37. For example, the input machine learning model 36 and the reference machine learning model 37 can be selected and loaded depending on the type of structures of the integrated circuit patterns of the object, e.g., logic structures or memory structures, line structures or circular pillar structures. The input machine learning model 36 and the reference machine learning model 37 can be selected and loaded depending on the size of the structures or depending on the critical dimension of the structures of the integrated circuit patterns. The input machine learning model 36 and the reference machine learning model 37 can also be selected and loaded depending on the types of defects to be detected, or depending on an expected or known defect size. The input machine learning model 36 and the reference machine learning model 37 can be selected and loaded depending on the appearance of the imaging dataset 22 and/or on the appearance of the reference dataset 28, or depending on image acquisition settings used for acquiring the imaging dataset 22 and/or the reference dataset 28, etc. In this way, the input machine learning model 36 and the reference machine learning model 37 only have to be trained once for each setting and can be saved to a memory or database after training. They can then be loaded from a memory or database for future applications with comparable settings or as pre-trained models, which can be adapted to the new setting by re-training.

Various methods can be used for detecting defects 24 in the feature space 38. In an example, detecting defects comprises computing a distance measure between the input representation 30 and the reference representation 34 in the feature space 38. For example, the distance measure can be a norm, e.g., an L1-norm, an L2-norm, etc. Alternatively, a cosine distance can be used that measures the angle between the input representation 30 and the reference representation 34 in the feature space 38. In case the input representation 30 and the reference representation 34 comprise a probability distribution in the feature space 38, the distance between the probability distributions can be measured using a Kullback-Leibler divergence.

In another example, detecting defects comprises applying a trained machine learning model to the input representation 30 and the reference representation 34 in the feature space 38 or to a function of the input representation 30 and the reference representation 34 in the feature space 38. The function can, for example, map the input representation 30 and the reference representation 34 to the difference vector or to a distance measure as described before and use the result of the function as input to the trained machine learning model. The trained machine learning model can use the pair of the input representation 30 and the reference representation 34 as input, or the result of the application of the function, e.g., the difference vector or distance measure. The trained machine learning model for defect detection can be trained jointly with the input machine learning model and the reference machine learning model, or sequentially. In case of a joint training, the training data must contain defective imaging datasets that are used to train the defect detection machine learning model or a defect detection branch within the same model.

The trained machine learning model for defect detection can, for example, comprise a one class SVM. A one class SVM only learns from defect-free inputs. Instead of using a hyperplane for separating two classes of instances, it finds the smallest possible hypersphere encompassing all instances, i.e., all defect-free inputs. Inputs lying outside the hypersphere can then be marked as defects 24. To prevent sensitivity to noise, the hypersphere does not have to encompass all of the defect-free inputs. The one class SVM can be trained on difference vectors of the input representation 30 and the reference representation 34.

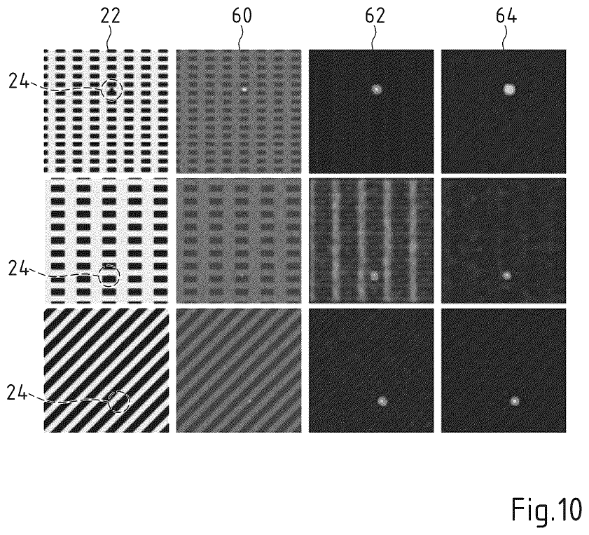

FIG. 10 shows defect detection results using different defect detection methods in the feature space 38 for an imaging dataset 22 and a reference dataset 28 of the same appearance. In the first column three different subsets 32 of imaging datasets 22 are shown, each of them comprising a defect 24, which is hard to detect.

The second column shows difference images 60 between the subset 32 of the imaging dataset 22 and a corresponding subset 32 of a reference dataset 28. The defect 24 is only visible in the first row. Thus, the defects 24 are very hard to detect by direct comparison in the image space.

The third column shows feature difference images 62. Each feature difference image 62 is obtained by generating an input representation 30 of the subset 32 of the imaging dataset 22 and a reference representation 34 of the subset 32 of the reference dataset 28 in the feature space 38 and computing the difference feature vector. The feature space 38 is obtained by training an autoencoder, which is used as input machine learning model 36 and as reference machine learning model 37. The autoencoder was trained on 25,000 defect-free images of size 448×448 using a batch size of 16, and an AdamW optimizer for 1000 epochs. The activations at the bottleneck 55 of the trained autoencoder were used as feature space 38, so the input representation 30 is obtained by presenting the subset 32 of the imaging dataset 22 to the trained autoencoder and obtaining the activation map at the bottleneck 55, and the reference representation 34 is obtained by presenting the corresponding subset 32 of the reference dataset 22 to the trained autoencoder and obtaining the activation map at the bottleneck 55.

To obtain a pixel wise segmentation, the feature difference vectors can be transformed back to the image space, e.g., by interpolation. Each feature difference vector entry is related to a receptive field in the subset 32 of the imaging dataset 22. Thus, for a pixel in the subset 32 of the imaging dataset 22 the corresponding feature difference image pixel can be obtained by setting the center pixel of the receptive field to the corresponding feature difference vector entry. In an example, the resulting feature difference image is then upscaled to the original subset size. In another example, further difference feature vectors are computed for shifted subsets 32, e.g., by repeatedly shifting the subsets 32 by one pixel. Thus, a combination of several grids of difference feature vectors is computed for multiple shifted subsets 32 of the imaging dataset 22. For example, if a difference feature vector grid exhibits a loss of resolution by a factor of 4 along both dimensions of the imaging dataset 22, 4*4=16 grids can be combined to form a grid of the original size of the subset 32. In another example, the feature difference vectors are not transformed back to the image space, i.e., the resolution is not adjusted. Instead, the defect detection algorithm 44 is applied to the difference feature vector grid of reduced resolution. The resulting defect scores can then be interpolated to the original size of the subset 32 of the imaging dataset 22. Alternatively, no interpolation can be carried out in case an accurate localization of the defects is not required.

The fourth column shows defect images 64 obtained by applying a trained one class SVM to the difference of the input representation 30 and the reference representation 34. A pixel wise segmentation in the image space can then be obtained as described before. The results show that the reliability of the defect detection is improved by mapping the subset 32 of the imaging dataset 22 to an input representation 30 in the feature space 38 and the corresponding subset 32 of the reference dataset 28 to a reference representation 34 in the feature space 38 and comparing the input representation 30 to the reference representation 34 in the feature space 38. In addition, this process is faster than comparing the autoencoder reconstruction of the subset 32 of the imaging dataset 22 in the image space to the autoencoder reconstruction of the subset 32 of the reference dataset 22 in the image space, since the forward pass of the autoencoder only has to be evaluated up to the one or more layers forming the feature space 38, e.g., the bottleneck 55 or preceding layers.

Thus, in an example, the method for detecting defects further comprises segmenting one or more of the detected defects by transforming a difference vector of the input representation 30 and the reference representation 34 back to the image space.

As an alternative to one class SVMs, other machine learning models can be used for defect detection, for example, supervised or semi-supervised machine learning models, in particular neural networks, that are trained using labeled training images, potentially including data augmentation and pseudo-labeling techniques, or random forests, Support Vector Data Description (SVDD), Isolation Forests, nearest neighbor based approaches, etc.

In an example, the method for detecting defects 24 further comprises classifying one or more of the detected defects 24 by applying a defect classification method to the input representation 30 in the feature space 38. The defect classification method can, for example, comprise another machine learning model, which is trained on pairs of input representations and corresponding defect classes. The defect classification method can also consider the reference representation 34. Alternatively, a random forest or an SVM can be trained for defect classification on input representations 30.

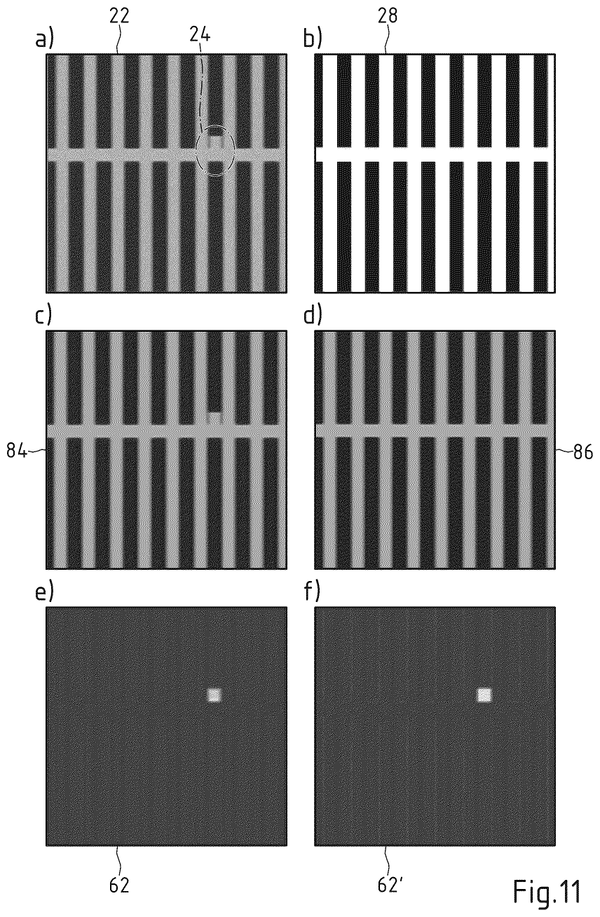

FIG. 11 shows a comparison of a subset 32 of an imaging dataset 22 including a defect 24 and a corresponding subset 32 of a reference dataset 28 in feature space 38. The subset 32 of the imaging dataset 22 in FIG. 11 a) and the corresponding subset 32 of the reference dataset 28 in FIG. 11 b) are mapped to the feature space 38 using an input neural network 50 and a reference neural network 52 each comprising a sequence of aligned intermediate layers as illustrated in FIG. 9. FIG. 11 c) shows a decoded input representation 84 of the subset 32 of the imaging dataset 22, and FIG. 11 d) shows a corresponding decoded reference representation 86 of the subset 32 of the reference dataset 28. FIG. 11 e) shows a feature difference image 62 obtained by computing the L2-norm in the feature space 38 between an input representation 30 of the subset 32 of the imaging dataset 22 and a reference representation 34 of the subset 32 of the reference dataset 28 in the feature space 38 and decoding the difference, optionally followed by interpolating to a higher resolution, to obtain the feature difference image 62 in image space. FIG. 11 f) shows a feature difference image 62′ obtained by computing the cosine distance in the feature space 38 between the input representation 30 of the subset 32 of the imaging dataset 22 and the reference representation 34 of the subset 32 of the reference dataset 28 in the feature space 38 and decoding the difference to obtain the feature difference image 62 in image space. The defect is clearly visible in both feature difference images 62, 62′.

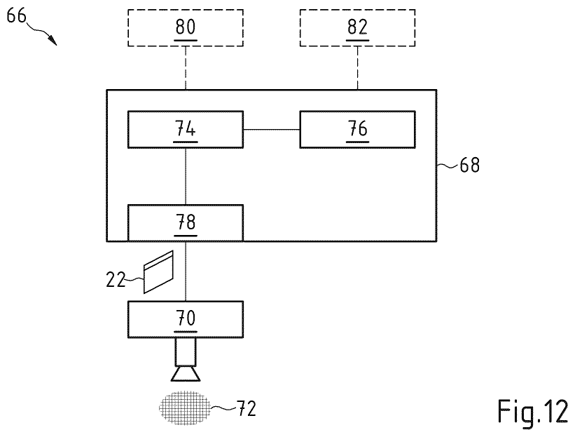

A system 66 for defect detection in an object 72 comprising integrated circuit patterns according to an embodiment of the invention illustrated in FIG. 12 comprises an imaging device 70 for obtaining an imaging dataset 22 of the object 72 comprising integrated circuit patterns and a data analysis device 68 comprising one or more processing devices 74 and one or more machine-readable hardware storage devices 76 comprising instructions that are executable by one or more processing devices 74 to perform operations comprising a computer implemented method 26 for defect detection, for defect segmentation or defect classification in an object 72 comprising integrated circuit patterns as described above.

The system 66 can optionally comprise a database 80 for loading and/or saving input machine learning models 36 and/or reference machine learning models 37 or training data. The imaging device 70 for obtaining an imaging dataset 22 of the object 72 comprising integrated circuit patterns can comprise a charged particle beam device, for example, a Helium ion microscope, a cross-beam device including FIB and SEM, an atomic force microscope or any charged particle imaging device, or an aerial image acquisition system. The imaging device 70 for obtaining an imaging dataset 22 of the object 72 comprising integrated circuit patterns can provide an imaging dataset 22 to the data analysis device 68. The data analysis device 68 includes one or more processors 74, e.g., implemented as a central processing unit (CPU) or graphics processing unit (GPU). The one or more processors 74 can receive the imaging dataset 22 via an interface 78. The one or more processors 74 can load program code from a hardware-storage device 76, e.g., program code for executing a computer implemented method 26 for detecting defects 24, for segmenting defects or for classifying defects according to an embodiment of the invention as described above. The one or more processor 74 can execute the program code. The system 66 can optionally comprise a user interface 82, e.g., for inspecting the feature space 38, input representations 30 or reference representations 34 in the feature space 38, the training progress of the input machine learning model 36 and/or the reference machine learning model 37, for selecting training parameters, etc.

The methods disclosed herein can, for example, be used during research and development of objects comprising integrated circuit patterns or during high volume manufacturing of objects comprising integrated circuit patterns, or for process window qualification or enhancement. In addition, the methods disclosed herein can also be used for defect detection of X-ray imaging datasets of objects comprising integrated circuit patterns, e.g., after packaging the semiconductor device for delivery.

In some examples, the object having integrated circuit patterns is a photolithography mask. After the defects are found using the methods and systems described above, the photolithography mask can be modified to repair or eliminate the defects. Repairing the defects on the mask can include, e.g., depositing materials on the mask using a deposition process, or removing materials from the mask using an etching process. Some defects can be repaired based on exposure with focused electron beams and adsorption of precursor molecules.

In some implementations, a repair device for repairing the defects on a mask can be configured to perform an electron beam-induced etching and/or deposition on the mask. The repair device can include, e.g. an electron source, which emits an electron beam that can be used to perform electron beam-induced etching or deposition on the mask. The repair device can include mechanisms for deflecting, focusing and/or adapting the electron beam. The repair device can be configured such that the electron beam is able to be incident on a defined point of incidence on the mask.

The repair device can include one or more containers for providing one or more deposition gases on the mask, which can be guided to the mask via one or more appropriate gas lines. The repair device can also include one or more containers for providing one or more etching gases on the mask, which can be provided on the mask via one or more appropriate gas lines. Further, the repair device can include one or more containers for providing one or more additive gases can be supplied to the one or more deposition gases and/or the one or more etching gases.

The repair device can include a user interface to allow an operator to, e.g., operate the repair device and/or read out data.

The repair device can include a computer unit configured to cause the repair device to perform one or more of the methods described herein, based at least in part on an execution of an appropriate computer program.

In some implementations, the information about the defects serve as feedback to improve the process parameters of the manufacturing process, e.g., exposure time, focus, illumination, etc., For example, after the defects are identified from a first photolithography mask or first batch of photolithography masks, the process parameters of the manufacturing process are adjusted to reduce defects in a second mask or a second batch of masks.

In some implementations, the data analysis device 68 can include one or more computers that include one or more data processors configured to execute one or more programs that include a plurality of instructions according to the principles described above. Each data processor can include one or more processor cores, and each processor core can include logic circuitry for processing data. For example, a data processor can include an arithmetic and logic unit (ALU), a control unit, and various registers. Each data processor can include cache memory. Each data processor can include a system-on-chip (SoC) that includes multiple processor cores, random access memory, graphics processing units, one or more controllers, and one or more communication modules. Each data processor can include millions or billions of transistors.

The methods described in this document can be carried out using one or more computing devices, which can include one or more data processors for processing data, one or more storage devices for storing data, and/or one or more computer programs including instructions that when executed by the one or more computing devices cause the one or more computing devices to carry out the method steps or processing steps. The one or more computing devices can include one or more input devices, such as a keyboard, a mouse, a touchpad, and/or a voice command input module, and one or more output devices, such as a display, and/or an audio speaker.

In some implementations, the one or more computing devices can include digital electronic circuitry, computer hardware, firmware, software, or any combination of the above. The features related to processing of data can be implemented in a computer program product tangibly embodied in an information carrier, e.g., in a machine-readable storage device, for execution by a programmable processor; and method steps can be performed by a programmable processor executing a program of instructions to perform functions of the described implementations. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

A computer program can be written in any form of programming language, including compiled or interpreted languages, and it can be deployed in any form, including as a stand-alone program or as a module, component, subroutine, or other unit suitable for use in a computing environment.

For example, the one or more computers can be configured to be suitable for the execution of a computer program and can include, by way of example, both general and special purpose microprocessors, and any one or more processors of any kind of digital computer. Generally, a processor will receive instructions and data from a read-only storage area or a random access storage area or both. Elements of a computer system include one or more processors for executing instructions and one or more storage area devices for storing instructions and data. Generally, a computer system will also include, or be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor, at least one data storage system (including volatile and non-volatile memory and/or storage elements), at least one wired or wireless input device or port, and at least one wired or wireless output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment”, “according to an example” or “according to an aspect” in various places throughout this specification are not necessarily all referring to the same embodiment, example or aspect, but may refer to different embodiments. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

The invention can be described by the following clauses:
1. Computer implemented method 26 for defect detection in an object 72 comprising integrated circuit patterns comprising:
   Obtaining an imaging dataset 22 and a reference dataset 28 of the object 72;
   Generating an input representation 30 of a subset 32 of the imaging dataset 22 and a reference representation 34 of a corresponding subset 32 of the reference dataset 28 in a feature space 38, wherein the feature space 38 is configured to preserve the information of the subset 32 of the imaging dataset 22 and of the subset 32 of the reference dataset 28 that is relevant for the detection of defects 24; and
   Detecting defects 24 in the object 72 by comparing the input representation 30 to the reference representation 34 in the feature space 38.
2. The method of clause 1, wherein the dimension of the feature space 38 is lower than the dimension of the subset 32 of the imaging dataset 22.
3. The method of any one of the preceding clauses, wherein the input representation 30 comprises a probability distribution in the feature space 38, and wherein the reference representation 34 comprises a probability distribution in the feature space 38.
4. The method of any one of the preceding clauses, wherein the appearance of the imaging dataset 22 differs from the appearance of the reference dataset 28, and wherein the appearance comprises at least one aspect from the group containing image statistics, image modality, image generation type, image alignment.
5. The method of any one of the preceding clauses, wherein the appearance of the reference dataset 28 is modified to imitate the appearance of the imaging dataset 22, or wherein the appearance of the imaging dataset 22 is modified to imitate the appearance of the reference dataset 28.
6. The method of clause 5, wherein the appearance of the respective dataset is modified by applying a trained machine learning model to the respective dataset.
7. The method of any one of the preceding clauses, wherein the feature space 38 is defined depending on meta information concerning the imaging dataset 22 and/or the reference dataset 28 and/or the integrated circuit patterns of the object and/or the defects 24 and/or the location of the subset 32 of the imaging dataset 22.
8. The method of any one of the preceding clauses, wherein generating the input representation 30 in the feature space 38 comprises applying a trained input machine learning model 36 to the subset 32 of the imaging dataset 22, and wherein generating the reference representation 34 in the feature space 38 comprises applying a trained reference machine learning model 37 to the subset 32 of the reference dataset 28.
9. The method of clause 8, wherein the input machine learning model 36 comprises an input neural network 50, and wherein the reference machine learning model 37 comprises a reference neural network 52, and wherein the feature space 38 comprises activations of one or more layers of the input neural network 50 and activations of one or more layers of the reference neural network 52.
10. The method of clause 8 or 9, wherein the input machine learning model 36 is trained to reconstruct the subset 32 of the imaging dataset 22 and/or wherein the reference machine learning model 37 is trained to reconstruct the subset 32 of the reference dataset 28.
11. The method of clause 9 or 10, wherein the input neural network 50 and the reference neural network 52 have a sequence 54 of at least one intermediate layer 51 in common.
12. The method of clause 11, wherein the architecture of the input neural network 50 and the architecture of the reference neural network 52 are configured such that the input neural network 50 and the reference neural network 52 share a sequence 54 of at least one intermediate layer 51.
13. The method of clause 11, wherein the input neural network 50 and the reference neural network 52 comprise an identical sequence 54 of at least one intermediate layer 51.
14. The method of any one of clauses 11 to 13, wherein the feature space 38 comprises activations of one or more of the at least one intermediate layer 51 of the common sequence 54, and wherein the input representation 30 of the subset 32 of the imaging dataset 22 in the feature space 38 comprises the activation of the one or more of the at least one intermediate layer 51 of the common sequence 54 when applying the input neural network 50 to the subset 32 of the imaging dataset 22, and wherein the reference representation 34 of the subset 32 of the reference dataset 28 comprises the activation of the one or more of the at least one intermediate layer 51 of the common sequence 54 when applying the reference neural network 28 to the subset 32 of the reference dataset 28.
15. The method of any one of clauses 9 to 14, wherein the input neural network 50 and the reference neural network 52 comprise an autoencoder.
16. The method of clause 15, wherein the encoder of the autoencoder of the input neural network 50 and the encoder of the autoencoder of the reference neural network 52 have a sequence 54 of at least one intermediate layer 51 in common.
17. The method of any one of clauses 8 to 16, wherein the reference machine learning model 37 differs from the input machine learning model 36.
18. The method of any one of clauses 8 to 16, wherein the reference machine learning model 37 is identical to the input machine learning model 36.
19. The method of any one of clauses 8 to 18, wherein the input machine learning model 36 and the reference machine learning model 37 are loaded from a memory or database 80 depending on meta information concerning the imaging dataset 22 and/or the reference dataset 28 and/or the integrated circuit patterns of the object 72 and/or the defects 24 and/or the input machine learning model 36 and/or the reference machine learning model 37.
20. The method of any one of the preceding clauses, wherein detecting defects 24 comprises computing a distance measure between the input representation 30 and the reference representation 34 in the feature space 38.
21. The method of any one of the preceding clauses, wherein detecting defects 24 comprises applying a trained machine learning model to the input representation 30 and the reference representation 34 in the feature space 38 or to a function 40 of the input representation 30 and the reference representation 34 in the feature space 38.
22. The method of any one of the preceding clauses, further comprising classifying one or more of the detected defects 24 by applying a defect classification method to the input representation 30 in the feature space 38.
23. A computer implemented method for training an input machine learning model 36 and/or a reference machine learning model 37 according to any one of clauses 8 to 18.
24. A computer-readable medium, on which a computer program executable by a computing device is stored, the computer program comprising code for executing a method of any one of the preceding clauses.
25. A computer program product comprising instructions which, when the program is executed by a computer, cause the computer to carry out a method of any one of the preceding method clauses.
26. A system 66 for defect detection in an object 72 comprising integrated circuit patterns, the system 66 comprising:
   an imaging device 70 configured to provide an imaging dataset 22 of the object 72 comprising integrated circuit patterns;
   one or more processing devices 74; and
   one or more machine-readable hardware storage devices 76 comprising instructions that are executable by the one or more processing devices 74 to perform operations comprising any one of the methods of the preceding method clauses.
27. A method comprising:
   detecting at least one defect in an object using the method for defect detection of any of clauses 1 to 22; and
   modifying the object to at least one of reduce, repair, or remove the at least one defect.
28. The method of clause 27 wherein the object comprises at least one of a photolithographic mask, a reticle, or a wafer.
29. The method of clause 27 or 28 wherein modifying the object comprises at least one of (i) depositing one or more materials onto the object, (ii) removing one or more materials from the object, or (iii) locally modifying a property of the object.
30. The method of clause 29 wherein locally modifying a property of the object comprises writing one or more pixels on the object to locally modify at least one of a density, a refractive index, a transparency, or a reflectivity of the object.
31. A method comprising:
   processing a first object using a manufacturing process that comprises at least one process parameter;
   detecting at least one defect in the first object using the method for defect detection of any one of clauses 1 to 22; and
   modifying the manufacturing process based on information about the at least one defect in the first object that has been detected to reduce the number of defects or eliminate defects in a second object to be produced by the manufacturing process.
32. The method of clause 31 wherein the object comprises at least one of a photolithographic mask, a reticle, or a wafer.
33. The method of clause 31 or 32 wherein modifying the manufacturing process comprises modifying at least one of an exposure time, focus, or illumination of the manufacturing process.
34. A method comprising:
   processing a plurality of regions on a first object using a manufacturing process that comprises at least one process parameter, wherein different regions are processed using different process parameter values;
   applying the method for defect detection of any one of clauses 1 to 22 to each of the regions to obtain information about zero or more defects in the region;
   identifying, using a quality criterion or criteria, a first region among the regions based on information about the zero or more defects;
   identifying a first set of process parameter values that was used to process the first region; and
   applying the manufacturing process with the first set of process parameter values to process a second object.
35. The method of clause 34 wherein the object comprises a photolithographic mask, a reticle, or a wafer, and the regions comprise dies on the mask, reticle, or wafer.

In summary, in one aspect, the invention relates to a computer implemented method for defect detection in an object comprising integrated circuit patterns comprising: obtaining an imaging dataset 22 and a reference dataset 28 of the object; generating an input representation 30 of a subset 32 of the imaging dataset 22 and a reference representation 34 of a corresponding subset 32 of the reference dataset 28 in a feature space 38; and detecting defects 24 in the object by comparing the input representation 30 to the reference representation 34 in the feature space 38. The invention also relates to a corresponding computer-readable medium, computer program product and system 66 for defect detection.

### REFERENCE NUMBER LIST

10, 10′ Photolithography system
12 Light source
14 Photolithography mask
16 Illumination optics
18 Projection optics
20 Wafer
22 Imaging dataset
24 Defect
26 Computer implemented method
28 Reference dataset
30 Input representation
32 Subset
34 Reference representation
36 Input machine learning model
37 Reference machine learning model
38 Feature space
40 Function
42 Comparison result
44 Defect detection algorithm
46 “defect-free”
48 “defective”
50 Input neural network
51 Intermediate layer
52 Reference neural network
53 Aligned layers
54, 54′ Sequence
55 Bottleneck
56 Appearance modifying machine learning model
58 Appearance modified reference dataset
60 Difference image
62, 62′ Feature difference image
64 Defect image
66 System
68 Data analysis device
70 Imaging device
72 Object
74 Processing device
76 Hardware-storage device
78 Interface
80 Database
82 User interface
84 Decoded input representation
86 Decoded reference representation
88, 88′ Output space

What is claimed is:

1. A computer implemented method for defect detection in an object comprising integrated circuit patterns comprising:
obtaining an imaging dataset and a reference dataset of the object;
generating an input representation of a subset of the imaging dataset and a reference representation of a corresponding subset of the reference dataset in a feature space, wherein the feature space is configured to preserve the information of the subset of the imaging dataset and of the subset of the reference dataset that is relevant for the detection of defects; and
detecting defects in the object by comparing the input representation to the reference representation in the feature space.

2. The method of claim 1, wherein the dimension of the feature space is lower than the dimension of the subset of the imaging dataset.

3. The method of claim 1, wherein the input representation comprises a probability distribution in the feature space, and wherein the reference representation comprises a probability distribution in the feature space.

4. The method of claim 1, wherein the appearance of the imaging dataset differs from the appearance of the reference dataset, and wherein the appearance comprises at least one aspect from the group containing image statistics, image modality, image generation type, image alignment.

5. The method of claim 1, wherein the appearance of the reference dataset is modified to imitate the appearance of the imaging dataset, or wherein the appearance of the imaging dataset is modified to imitate the appearance of the reference dataset.

6. The method of claim 5, wherein the appearance of the respective dataset is modified by applying a trained machine learning model to the respective dataset.

7. The method of claim 1, wherein the feature space is defined depending on at least one of meta information concerning the imaging dataset, the reference dataset, the integrated circuit patterns of the object, the defects, or the location of the subset of the imaging dataset.

8. The method of claim 1, wherein generating the input representation in the feature space comprises applying a trained input machine learning model to the subset of the imaging dataset, and wherein generating the reference representation in the feature space comprises applying a trained reference machine learning model to the subset of the reference dataset.

9. The method of claim 8, wherein the input machine learning model is trained to reconstruct the subset of the imaging dataset and/or wherein the reference machine learning model is trained to reconstruct the subset of the reference dataset.

10. The method of claim 8, wherein the input machine learning model comprises an input neural network, and wherein the reference machine learning model comprises a reference neural network, and wherein the feature space comprises activations of one or more layers of the input neural network and activations of one or more layers of the reference neural network.

11. The method of claim 10, wherein the input neural network and the reference neural network have a sequence of at least one intermediate layer in common.

12. The method of claim 11, wherein the architecture of the input neural network and the architecture of the reference neural network are configured such that the input neural network and the reference neural network share a sequence of at least one intermediate layer.

13. The method of claim 11, wherein the input neural network and the reference neural network comprise an identical sequence of at least one intermediate layer.

14. The method of claim 11, wherein the feature space comprises activations of one or more of the at least one intermediate layer of the common sequence, and wherein the input representation of the subset of the imaging dataset in the feature space comprises the activation of the one or more of the at least one intermediate layer of the common sequence when applying the input neural network to the subset of the imaging dataset, and wherein the reference representation of the subset of the reference dataset comprises the activation of the one or more of the at least one intermediate layer of the common sequence when applying the reference neural network to the subset of the reference dataset.

15. The method of claim 10, wherein the input neural network and the reference neural network each contain a sequence comprising the same number of one or more corresponding, structurally identical intermediate layers.

16. The method of claim 10, wherein each two corresponding intermediate layers of the sequences are aligned, such that they produce at least similar activations, when presenting a defect-free subset of the imaging dataset to the input neural network and a corresponding subset of the reference dataset to the reference neural network.

17. The method of claim 10, wherein the input neural network and the reference neural network comprise an autoencoder.

18. The method of claim 17, wherein the encoder of the autoencoder of the input neural network and the encoder of the autoencoder of the reference neural network have a sequence of at least one intermediate layer in common.

19. The method of claim 8, wherein the reference machine learning model differs from the input machine learning model.

20. The method of claim 8, wherein the reference machine learning model is identical to the input machine learning model.

21. The method of claim 8, wherein the input machine learning model and the reference machine learning model are loaded from a memory or database depending on at least one of meta information concerning the imaging dataset, the reference dataset, the integrated circuit patterns of the object, the defects, the input machine learning model, or the reference machine learning model.

22. The method of claim 1, wherein the input machine learning model is trained to map the subset of the imaging dataset to an output space, and wherein the reference machine learning model is trained to map the subset of the reference dataset to the same output space.

23. The method of claim 1, wherein detecting defects comprises computing a distance measure between the input representation and the reference representation in the feature space.

24. The method of claim 1, wherein detecting defects comprises applying a trained machine learning model to the input representation and the reference representation in the feature space or to a function of the input representation and the reference representation in the feature space.

25. The method of claim 1, further comprising classifying one or more of the detected defects by applying a defect classification method to the input representation in the feature space.

26. A computer implemented method for training an input machine learning model and/or a reference machine learning model according to claim 8.

27. A computer implemented method for training an input machine learning model and/or a reference machine learning model according to claim 17 by minimizing a loss function comprising an alignment loss that penalizes the deviation of each activation of a layer of the one or more layers of the input neural network from the activation of the corresponding layer of the one or more layers of the reference neural network, when presenting a defect-free subset of the imaging dataset to the input neural network and a corresponding subset of the reference dataset to the reference neural network.

28. The method of claim 26, wherein the input neural network and the reference neural network are trained jointly.

29. The method of claim 26, wherein the input neural network and the reference neural network are trained sequentially.

30. A computer-readable medium, on which a computer program executable by a computing device is stored, the computer program comprising code for executing the method of claim 1.

31. A computer program product comprising instructions which, when the program is executed by a computer, cause the computer to carry out the method of claim 1.

32. A system for defect detection in an object comprising integrated circuit patterns, the system comprising:
an imaging device configured to provide an imaging dataset of the object comprising integrated circuit patterns;
one or more processing devices; and
one or more machine-readable hardware storage devices comprising instructions that are executable by the one or more processing devices to perform operations comprising the method of claim 1.
